(19) United States
(12) Patent Application Publication
(10) Pub. No.: US 2006/0037029 A1
(43) Pub. Date: Feb. 16, 2006

(54) Computer-readable program product, process and apparatus for installing device driver

(75) Inventor: Takafumi Yamada, Nagoya-shi (JP)

Correspondence Address: BANNER & WITCOFF, LTD.;Counsel for Brother Industries, 1001 G STREET, N.W., 11TH FLOOR, WASHINGTON, DC, 20001-4597, US

(73) Assignee: Brother Kogyo Kabushiki Kaisha, Nagoya-shi (JP)

(21) Appl. No.: 11/200,154

(22) Filed: Aug. 10, 2005

(30) Foreign Application Priority Data
Aug. 10, 2004 (JP) 2004-233437

(51) Int. Cl. G06F 9/44; G06F 9/445

(52) U.S. Cl. 719/327; 717/176

(57) ABSTRACT

A computer technology of installing a device driver is disclosed. The technology is used in an apparatus for processing information using a computer in an environment in which the apparatus is connected with a device via a selected one of interfaces different in kind. The technology includes: the technique of determining whether each interface is available to the apparatus, thereby recognizing interface availability; the technique of, prior to an event of a user to specify one of the interfaces, presenting to the user, selection support information supporting the user in specifying one of the interfaces, depending upon the interface availability, thereby allowing the user to specify one of the interfaces in conformity with the interface availability; and the technique of selecting one of device drivers different in kind which are all available to the device, in conformity with the specified interface, thereby installing the selected device driver to the apparatus.

This application is based on Japanese Patent Application No. 2004-233437 filed Aug. 10, 2004, the content of which is incorporated hereinto by reference.

### CROSS-REFERENCE TO RELATED APPLICATIONS

Not Applicable.

### BACKGROUND

1. Field

The field relates to a technique of installing a device driver in an apparatus for processing information, and more particularly to a technique of installing a device driver in conformity with an available interface.

2. Related Art

Currently, there is performed for enabling a device in an apparatus for processing information such as a personal computer, a process in which a device driver, which is an application program executed by a computer for enabling the apparatus to operate the device, is installed in the apparatus, allowing the device to be operable under the device driver.

In addition, it has been popularized recently to use an install program configured to perform installation in a dialogue manner (commonly referred to as a Wizard manner) through user actions for verification or for entry, for allowing even a user without knowledge of program installation to easily perform an operation for installation.

As disclosed in Japanese Patent Publication No. 2003-216378, an example of such a technique has been proposed, which is implemented for installing a particular device driver in conformity with a particular interface (an interface for a Plug-and-Play-compatible peripheral, for example, a USB interface), and in which, in response to a user action for instructions of device-driver install (a user action for indicating whether or not a particular device is the Plug-and-Play-compatible peripheral, for example, a user action for turning on a corresponding check box on a display), the particular device driver is installed according to the same procedure irrespective of the kind of the particular device driver to be installed.

### BRIEF SUMMARY

For installing a device driver for a particular interface, the above-described technique requires the user to perform an action for instructions of device-driver install. For this reason, when the technique is practiced by the direction of the user, if the user lacks adequate knowledge about a related interface, then the user fails to perform a correct action for instructions of install, resulting in creation of the likelihood that a required installation is not completed successfully.

For example, where a device driver for a particular interface is required to be installed in an apparatus, if the user, nevertheless, failed to perform correctly an action for instructions of device-driver install, then there is installed an unexpected device driver different from the device driver to be installed in conformity with the particular interface. As a result, the apparatus fails to operate properly the particular device.

Such a drawback is caused for the reasons that the apparatus is constructed, for practice of the above-described technique, such that individual operations for installation are advanced in a common fashion, without considering what kind of an interface has been provided to the apparatus.

It is therefore an object of the present invention to provide techniques of installing a device driver in an apparatus for processing information, and of installing a device driver in conformity with an available interface.

According to the present invention, a process is provided which is operable in a computer of an apparatus for processing information in an environment in which the apparatus is connected with a device via a selected one of a plurality of interfaces different in kind, and which is for installing to the apparatus a device driver in conformity with the connected device.

The process comprises the steps of:

determining whether or not each of the plurality of interfaces is available to the apparatus, thereby recognizing interface availability;

prior to an event of a user to specify one of the plurality of interfaces, presenting to the user, selection support information supporting the user in specifying one of the plurality of interfaces, depending upon the recognized interface availability, thereby allowing the user to specify one of the plurality of interfaces in conformity with the recognized interface availability; and

selecting one of a plurality of device drivers different in kind which are all available to the device, in conformity with the specified interface, thereby installing the selected device driver to the apparatus.

Once the above process according to the present invention is practiced, the selection support information supporting the user in specifying one of the plurality of interfaces is presented to the user, prior to the user specifying a particular interface, depending upon the availability of each of the plurality of interfaces.

Based on the presented selection support information, the user is allowed to specify one of the plurality of interfaces. Therefore, the user is allowed to specify one of the plurality of interfaces more correctly than where such selection support information is not presented to the user.

As a result, when the process according to the present invention is practiced, the user selection of a particular interface, although requires the intervention of the user, is performed in consideration of the kind of an interface which has been provided to the apparatus in which a particular device program is to be installed.

Therefore, the process according to the present invention prevents device-driver installation from failing to be completed successfully due to the user incorrect selection of an interface.

The term “device” used throughout the description may be interpreted to mean, for example, a printer, a modem, a scanner, a disc drive, an MO drive, or the like. On the other hand, the term “interface” used therein may be interpreted to mean, for example, a network interface, a USB interface, a parallel interface, or the like.

The term “apparatus” used throughout the description may be interpreted to mean, for example, a personal computer, a business computer, a desk-top computer, a lap-top computer, a stand-alone computer, a networked computer, or the like.

When the above process according to the present invention is practiced, the presentation of the selection support information to the user may be achieved visually (in text or graphics) or auditorily (in voice or sound). For example, for the apparatus including a display unit, the process may be practiced in a manner in which the selection support information is expressed by a content (e.g., data) displayed on the display unit, and the user is allowed to specify a particular interface through the displayed content.

### BRIEF DESCRIPTION OF THE SEVERAL VIEWS OF THE DRAWINGS

The foregoing summary, as well as the following detailed description of preferred embodiments, will be better understood when read in conjunction with the appended drawings. For the purpose of illustration, there are shown in the drawings embodiments which are presently preferred. It should be understood, however, that the precise arrangements and instrumentalities shown are not limiting. In the drawings:

FIG. 1 is a block diagram schematically illustrating the hardware construction of a personal computer constructed according to a first embodiment;

FIG. 2 is a flow chart schematically illustrating an install program executed by a controller 12 illustrated in FIG. 1;

FIG. 3A is a representation of an example of an install start screen displayed at the initiation of the install program illustrated in FIG. 2;

FIG. 3B is a representation of an example of an interface selection screen displayed by the implementation of a step S160 illustrated in FIG. 2;

FIG. 3C is a representation of an example of an install finish screen displayed by the implementation of a step S190 illustrated in FIG. 2;

FIG. 4 is a block diagram schematically illustrating the hardware and software construction of the personal computer illustrated in FIG. 1, for explanation of a plurality of elements needed for understanding the install program illustrated in FIG. 2, and interactions between these elements;

FIG. 5 is a view schematically illustrating the content of an availability table 52 illustrated in FIG. 4;

FIG. 6A is a representation of an example of a device selection screen displayed by the implementation of a step S170 illustrated in FIG. 2;

FIG. 6B is a representation of an example of a port selection screen displayed by the implementation of the step S170;

FIG. 6C is a representation of an example of a connection verification screen displayed by the implementation of a step obtained by modifying the step S440 illustrated in FIG. 8;

FIG. 7 is a flow chart schematically illustrating the detailed content of a step S120 illustrated in FIG. 2, in the name of a first status check routine;

FIG. 8 is a flow chart schematically illustrating the detailed content of a step S130 illustrated in FIG. 2, in the name of a second status check routine;

FIG. 9 is a flow chart schematically illustrating the detailed content of a step S130 illustrated in FIG. 2, in the name of a third status check routine;

FIG. 10 is a view schematically illustrating the content of a priority table 70 used for the implementation of a step S150 illustrated in FIG. 2 and a step S550 illustrated in FIG. 11;

FIG. 11 is a flow chart schematically illustrating an install program executed by a personal computer constructed according to a second embodiment; and

FIG. 12 is a representation of an example of an environment selection screen displayed by the implementation of a step S502 illustrated in FIG. 11.

### DETAILED DESCRIPTION

The object mentioned above may be achieved according to any one of the following modes.

These modes will be stated below so as to be sectioned and numbered, and so as to depend upon the other mode or modes, where appropriate. This is for a better understanding of some of a plurality of technological features and a plurality of combinations thereof disclosed in this description, and does not mean that the scope of these features and combinations is interpreted to be limited to the scope of the following modes.

That is to say, it should be interpreted that it is allowable to select the technological features which are stated in this description but which are not stated in the following modes, as the technological features.

Furthermore, stating each one of the modes in such a dependent form as to depend from the other mode or modes does not exclude the possibility that the technological features set forth in a dependent-form mode become independent of those set forth in the corresponding depended mode or modes and to be removed therefrom. It should be interpreted that the technological features set forth in a dependent-form mode is allowed to become independent, where appropriate.

(1) In a computer of an apparatus for processing information in an environment in which the apparatus is connected with a device via a selected one of a plurality of interfaces different in kind, a process for installing to the apparatus a device driver in conformity with the connected device, the process comprising the steps of:

determining whether or not each of the plurality of interfaces is available to the apparatus, thereby recognizing interface availability;

prior to an event of a user to specify one of the plurality of interfaces, presenting to the user, selection support information supporting the user in specifying one of the plurality of interfaces, depending upon the recognized interface availability, thereby allowing the user to specify one of the plurality of interfaces in conformity with the recognized interface availability; and

selecting one of a plurality of device drivers different in kind which are all available to the device, in conformity with the specified interface, thereby installing the selected device driver to the apparatus.

In the process according to the above mode (1), the selection support information supporting the user in specifying one of the plurality of interfaces is presented to the user, prior to the user specifying a particular interface, depending upon the availability of each of the plurality of interfaces.

Based on the presented selection support information, the user is allowed to specify one of the plurality of interfaces. Therefore, the user is allowed to specify one of the plurality of interfaces more correctly than where such selection support information is not presented to the user.

As a result, when the process according to the above mode (1) is practiced, the user selection of a particular interface, although requires the intervention of the user, is performed in consideration of the kind of an interface which has been provided to the apparatus in which a particular device program is to be installed.

Therefore, the process according to the above mode (1) prevents device-driver installation from failing to be completed successfully due to the user incorrect selection of an interface.

When the above process according to the above mode (1) is practiced, the presentation of the selection support information to the user may be achieved visually (in text or graphics) or auditorily (in voice or sound). For example, for the apparatus including a display unit, the process may be practiced in a manner in which the selection support information is expressed by a content (e.g., data) displayed on the display unit, and the user is allowed to specify a particular interface through the displayed content.

The “determining step” set forth in the above mode (1) may be configured, for example, to make a determination as to whether or not each of the plurality of interfaces has been provided to the apparatus, such as stated in the following mode.

(2) The process according to mode (1), wherein the apparatus comprises:

an input unit for allowing the user to enter a user indication into the apparatus, depending on a user action; and

a display unit for displaying information to the user, and

wherein the presenting step comprises the steps of:

causing the display unit to display an interface selection screen which is configured for prompting the user to specify one of the plurality of interfaces and for displaying the selection support information; and

in response to the input unit recognizing the user action for specifying one of the plurality of interfaces during display of the interface selection screen, identifying the specified interface based on a content of the user action.

Once the process according to the above mode (2) is implemented, there is displayed on the display unit the interface selection screen configured to prompt the user to specify one of the plurality of interfaces. The interface selection screen is displayed by the display unit, for visually presenting the selection support information to the user.

The user is allowed to perform an action for specifying one of the plurality of interfaces, during the display of the interface selection screen. The user views the interface selection screen displayed in a manner reflecting the content of the selection support information, and, with reference to the content, the user determines one of the plurality of interfaces which is to be specified. That is to say, the user is allowed to perform an action for specifying a particular interface, with the aid of the selection support information.

Once the input unit recognizes a user action, one of the interfaces which has been specified by the user is identified through the content of the recognized user action. After the kind of the interface specified by the user is identified, the apparatus becomes enabled to select one of the plurality of device drivers which conforms with the interface specified by the user, and to install the selected device driver in the apparatus.

Thus, when the process according the above mode (2) is practiced, the interface selection screen is displayed by the display unit, in a displayed manner variable depending on whether or not each interface is available (whether or not each interface has been provided to the apparatus), thereby allowing the user to specify a particular interface through the content displayed by the display unit. As a result, the user is allowed to correctly specify a particular interface, with the aid of the interface selection screen, irrespective of whether or not the user has knowledge of a computer technology.

The “input unit” set forth in the above mode (2) may be formed as, for example, a keyboard, a mouse, a joystick, a touch pad, a touch screen, a light pen, a trackball, a voice input device, or the like.

The “display unit” set forth in the above mode (2) may be formed as, for example, a flat-panel display, an LCD, a video display, a plasma display, a CRT, or the like.

(3) The process according to mode (1) or (2), wherein the determining step comprises the step of determining whether or not each of the plurality of interfaces has been provided to the apparatus, and

wherein the presenting step comprises the step of presenting to the user the selection support information to inform the user that the user can specify any one of at least one of the plurality of interfaces which is determined to have been provided to the apparatus.

Once the process according to the above mode (3) is practiced, there is presented to the user, the selection support information indicating that each of at least one of the plurality of interfaces which has been determined to have been provided to the apparatus is selectable by the user.

Therefore, the process according to the above mode (3) allows the user to specify a particular interface with reference to the selection support information. As a result, the user is prevented from incorrectly specifying an interface which has not been provided to the apparatus, and eventually a device driver corresponding to an interface which has not been provided to the apparatus is prevented from being unexpectedly installed in the apparatus.

The process according to the above mode (3) may employ various arrangements for presenting to the user the selection support information indicating which interface is selectable by the user.

For example, where the apparatus is configured such that the user is made to specify a particular interface through the content displayed by the display unit, such that the plurality of interfaces are displayed by the display unit in association with a plurality of options (e.g., a plurality of radio button options, or a plurality of check boxes), respectively, and such that a particular interface is finally specified as one corresponding to a selected one of the displayed options, in response to an action of the user for verifying the selected option, an arrangement may be employed in which at least one of the plurality of options that corresponds to at least one interface determined to have been provided to the apparatus is initially displayed in a selected state (an on-state, a picked state, or a checked state).

An alternative arrangement may be employed in which at least one of the plurality of options that corresponds to at least one interface determined to have been provided to the apparatus, is each displayed by the display unit as an option selectable by the user.

A still alternative arrangement may be employed in which the plurality of options are displayed by the display unit together with a visual representation (e.g., in text, graphics, etc.) for identifying at least one interface determined to have been provided to the apparatus, and for indicating to the user that the user specify L the at least one interface.

The “determining step” set forth in the above mode (3) may be configured, for example, such as stated in the following mode, to make both a determination as to each of the plurality of interfaces has been provided to the apparatus, and a determination as to whether at least one interface determined to have provided to the apparatus has been connected to a particular device.

(4) The process according to any one of modes (1)-(3), wherein the determining step comprises the steps of:

determining whether or not each of the plurality of interfaces has been provided to the apparatus; and

determining whether or not the device has been connected with each of at least one of the plurality of interfaces which is determined to have been provided to the apparatus, and

wherein the presenting step comprises the step of presenting to the user the selection support information to inform the user that it is recommended that the user specify at least one of the plurality of interfaces which is determined to have been provided to the device.

Once the process according to the above mode (4) is implemented, there is displayed to the user, the selection support information indicating that the user should specify at least one of the plurality of interfaces which has been provided to the apparatus, and with which the device has been connected, thereby allowing the user to specify a particular interface, with the aid of the selection support information.

Therefore, the process according to the above mode (4) allows the user to specify a particular interface with reference to the selection support information reflecting both information relating to an interface or more, and information relating to a device or more. As a result, the user is prevented from incorrectly specifying an interface which has not been provided to the apparatus, and from incorrectly specifying an interface to which a particular device has not been connected.

Accordingly, the process according to the above mode (4) prevents an install of a device driver conforming with an interface not provided to the apparatus from being installed, and of device driver conforming with an interface to which a particular device has not connected.

The process according to the above mode (4) may employ various arrangements for presenting to the user the selection support information indicating that it is recommended that the user specify an interface determined to have been connected with a particular device.

For example, where the apparatus is configured such that the user is made to specify a particular interface through the content displayed by the display unit, such that the plurality of interfaces are displayed by the display unit in association with a plurality of options (e.g., a plurality of radio button options, or a plurality of check boxes), respectively, and such that a particular interface is finally specified as one corresponding to a selected one of the displayed options, in response to an action of the user for verifying the selected option, an arrangement may be employed in which at least one of the plurality of options that corresponds to at least one interface determined to have been connected to a particular device is initially displayed in a selected state (an on-state, a picked state, or a checked state).

An alternative arrangement may be employed in which at least one of the plurality of options that corresponds to at least one interface determined to have been connected to a particular device, is each displayed by the display unit as an option selectable by the user.

A still alternative arrangement may be employed in which the plurality of options are displayed by the display unit together with a visual representation (e.g., in text, graphics, etc.) for identifying at least one interface determined to have been connected to a particular device, and for indicating to the user that the user should specify the at least one interface.

(5) The process according to any one of modes (1)-(4), further comprising the step of defining the selection support information based on the recognized interface availability, and

wherein the presenting step comprises the step of presenting to the user the defined selection support information, thereby allowing the user to specify one of the plurality of interfaces in conformity with the recognized interface availability.

Once the process according to the above mode (5) is implemented, the selection support information, upon being defined based on the interface availability, is presented to the user. The user is allowed, with reference to the selection support information, to specify any one of the plurality of interfaces, in conformity with the interface availability.

The defining step set forth in the above mode (5) may be implemented in an arrangement defining the content of the selection support information based on only the interface availability. Alternatively, the defining step may be implemented in an arrangement in which the selection support information is defined in content based on not only the interface availability, but also the value or state of at least one other parameter.

The latter arrangement would allow the user to specify a particular interface with reference to the selection support information reflecting not only the interface availability but also the value or state of at least one other parameter. If this arrangement is practiced, for example, where a determination only based on the interface availability would result in more than one (provisional candidate interfaces) of the plurality of interfaces (original candidate interfaces) which each satisfy the requirements, the apparatus reduces the number of the provisional candidate interfaces owing to the consideration of the value or state of the at least one other parameter.

The “at least one other parameter” set forth in the above mode (5) may be any kind of parameter, provided that it is useful in determining an interface to be specified by the user. The “at least one other parameter” may be, for example, such as stated in the following mode, priority established between the plurality of interfaces.

(6) The process according to mode (5), wherein the defining step comprises the step of defining the selection support information in conformity with the recognized interface availability, and in conformity with pre-established priority for operation between the plurality of interfaces.

Once the process according to the above mode (6) is practiced, the selection support information is defined so as to conform with the interface availability and priority pre-established for operation between the plurality of interfaces.

Therefore, the process according to the above mode (6) allows the selection support information presented to the user for requesting the user to specify a particular interface, to be defined more accurately by reference to not only the interface availability but also the priority established between the plurality of interfaces.

The “priority” set forth in the above mode (6), although may be established according to any rule, may be preferably established according to, for example, a rule indicating that a popularized interface has priority over the remainder, or a rule indicating that an interface to be suitably connected to a particular device has priority over other the remainder.

A case exists where the kind of a device driver is varied depending on the kind of a device operable under the corresponding device driver, and where the kind of an interface of an apparatus for processing information is varied depending on the kind of a device with which the apparatus is connected via the interface. That is to say, in this case, variations in the kind of a device driver would invite variations in the kind of an interface of the apparatus with which the device is to be connected.

In view of the above findings, the “priority” set forth in the above mode (6) may be established, for example, such as stated in the following mode, so as to be varied depending on the kind of a device driver to be installed.

(7) The process according to mode (6), wherein the priority is pre-established to be varied depending on a kind of one of the plurality of device drivers which is to be installed.

Once the process according to the above mode (7) is practiced, the content of the selection support information is defined so as to reflect the priority variable depending on the kind of a device driver to be installed, and the thus-defined selection support information is presented to the user.

Therefore, the process according to the above mode (7) allows the user to correctly specify a particular interface with reference to the selection support information reflecting not only the interface availability but also the kind of a device driver to be installed.

An apparatus for processing information to which a device driver is to be installed may be used in an environment in which the apparatus is used stand-alone for personal purposes at home, or may be used in an environment in which the apparatus is used in connection with a network for business or commercial purposes in office, etc.

Depending on the kind of such an environment, the kind of an interface to which a particular device is to be connected is likely to be varied. More specifically, an interface of the kind that allows a direct connection (either wired or wireless) with a particular device is typically used in an environment in which the apparatus is stand-alone in use, while an interface of the kind that allows a connection with a particular device via a network in an environment in which the apparatus is networked in use.

As will be evident from the above explanation, a tendency exists in which variations in the kind of an environment in which the apparatus operates result in variations in the kind of an interface of the apparatus with which a particular device operable under a particular device driver is to be connected. Therefore, the “priority” set forth in the above mode (7) may be established, for example, such as stated in the following mode, so as to be varied depending on the kind of the operating environment of the apparatus.

(8) The process according to mode (6) or (7), further comprising the step of allowing the user to specify an operating environment in which the apparatus operates, and

wherein the priority is pre-established to be varied depending on a kind of the specified operating environment.

Once the process according to the above mode (8) is implemented, the selection support information is defined so as to reflect the priority variable depending on the kind of the operating environment of the apparatus, and the thus-defined selection support information is presented to the user.

Therefore, the process according to the above mode (8) allows the user to correctly specify a particular interface with reference to the selection support information reflecting not only the interface availability but also the kind of the operating environment of the apparatus.

(9) The process according to mode (8), wherein the operating environment is selected from a stand-alone environment in which the apparatus is communicated with the device without intervention of any network, and a network environment in which the apparatus is communicated with the device via a network.

Even after a device driver is installed, a need arises of updating the device driver, and a need arises of re-installing the device driver because the device driver has been damaged due to some cause.

Such needs are fulfilled by updating only the device driver, and, typically, does not require any modification in the kind of an interface of the apparatus with which a particular device is connected.

Therefore, it is preferable that, prior to re-install of a device driver identical in kind to the previous one, the selection support information is presented to the user which indicates that the user should specify an interface identical in kind to the previous one, for example, such as stated in the following mode.

Presentation of such selection support information to the user for allowing the user to specify a particular interface is more advantageous in preventing the user from repeating incorrectly an action for specifying a particular interface.

(10) The process according to any one of modes (1)-(9), wherein the apparatus comprises a storage for storing information,

wherein the process further comprises the step of storing in the storage, information for identifying one of the plurality of interfaces which corresponds to one of the plurality of device drivers which has been installed within the apparatus, and

wherein the presenting step comprises the step of, after the one device driver has been installed within the apparatus, prior to another event of installation, presenting to the user the selection support information to inform the user that it is recommended that the user specify the interface identified by the information stored in the storage.

Once the process according to the above mode (10) is implemented, there is stored information indicating an interface corresponding to a device driver previously installed. Thereafter, prior to another event of installation of the same device driver, there is presented to the user the selection support information indicating that the user should specify the interface identified by the stored information.

This allows the user to specify a particular interface with reference to the selection support information, thereby avoiding the user from incorrectly repeating an action for specifying a particular interface.

The process according to the above mode (10) may employ various arrangements for presenting to the user the selection support information indicating that it is recommended that the user specify an interface identified by the information.

For example, where the apparatus is configured, such that the user is made to specify a particular interface through the content displayed by the display unit, such that the plurality of interfaces are displayed by the display unit in association with a plurality of options, respectively, and such that a particular interface is finally specified as one corresponding to a selected one of the displayed options, in response to an action of the user for verifying the selected option, an arrangement may be employed in which at least one of the plurality of options that corresponds to at least one interface identified by the information stored in the storage is initially displayed in the selected state.

An alternative arrangement may be employed in which at least one of the plurality of options that corresponds to at least one interface identified by the information stored in the storage, is each displayed by the display unit as an option selectable by the user.

A still alternative arrangement may be employed in which the plurality of options are displayed by the display unit together with a visual representation (e.g., in text, graphics, etc.) for identifying at least one interface identified by the information stored in the storage, and for indicating to the user that the user should specify the at least one interface.

(11) An install program to be executed in an apparatus for processing information using a computer, the install program being executed by the computer for implementing the process according to any one of modes (1)-(10).

The execution of the install program according to the above mode (11) provides the same function and effects as when the process according to any one of the previous modes (1)-(10) is practiced.

The “program” in the above mode (11) may be interpreted to incorporate not only a combination of instructions implemented by a computer to perform the functions of the program, but also files, data, etc. processed depending on each of the instructions.

(12) A computer-readable storage medium which has stored therein the install program according to mode (11).

The execution of the install program which has been stored in the storage medium according to the above mode (12) provides the same function and effects as when the process according to any one of the previous modes (1)-(10) is practiced.

The “storage medium” in the above mode (12) may be realized in different types, including a magnetic recording medium, such as a flexible-disc, an optical recording medium, such as a CD and a CD-ROM, an optical-magnetic recording medium, such as an MO, an un-removable storage, such as a ROM, for example.

It is added that the storage medium may be an example of a computer-readable program product which covers any kinds of products having stored therein a particular computer program.

(13) An apparatus for processing information using a computer, the apparatus having installed therein the install program according to mode (11).

The execution of the install program in the apparatus according to the above mode (13) by its computer provides the same function and effects as when the process according to any one of the previous modes (1)-(10) is practiced.

(14) An apparatus for processing information using a computer, the apparatus having installed therein a device driver as a result of execution of the install program according to mode (11).

(15) An apparatus for processing information using a computer in an environment in which the apparatus is connected with a device via a selected one of a plurality of interfaces different in kind, the apparatus comprising:

a determining section determining whether or not each of the plurality of interfaces is available to the apparatus, thereby recognizing interface availability;

a connection selection section, prior to an event of a user to specify one of the plurality of interfaces, presenting to the user, selection support information supporting the user in specifying one of the plurality of interfaces, depending upon the recognized interface availability, thereby allowing the user to specify one of the plurality of interfaces in conformity with the recognized interface availability; and

an installation section selecting one of a plurality of device drivers different in kind which are all available to the device, in conformity with the specified interface, thereby installing the selected device driver to the apparatus.

The apparatus according to the above mode (15) provides the same functions and effects as the process according to the above mode (1), and various changes and modifications may be made in the apparatus without departing from its spirit, similarly to the process according to the above mode (1).

(16) The apparatus according to mode (15), further comprising:

an input unit for allowing the user to enter a user indication into the apparatus, depending on a user action; and

a display unit for displaying information to the user, and

wherein the connection selection section comprises:

a displaying division causing the display unit to display an interface selection screen which is configured for prompting the user to specify one of the plurality of interfaces and for displaying the selection support information; and

an identifying division, in response to the input unit recognizing the user action for specifying one of the plurality of interfaces during display of the interface selection screen, identifying the specified interface based on a content of the user action.

The apparatus according to the above mode (16) provides the same functions and effects as the process according to the above mode (2), and various changes and modifications may be made in the apparatus without departing from its spirit, similarly to the process according to the above mode (2).

(17) The apparatus according to mode (15) or (16), wherein the determining section comprises a determining division determining whether or not each of the plurality of interfaces has been provided to the apparatus, and

wherein the connection selection section comprises a presenting division presenting to the user the selection support information to inform the user that the user can specify any one of at least one of the plurality of interfaces which is determined to have been provided to the apparatus.

The apparatus according to the above mode (17) provides the same functions and effects as the process according to the above mode (3), and various changes and modifications may be made in the apparatus without departing from its spirit, similarly to the process according to the above mode (3).

(18) The apparatus according to any one of modes (15)-(17), wherein the determining section comprises:

a first division determining whether or not each of the plurality of interfaces has been provided to the apparatus; and

a second division determining whether or not the device has been connected with each of at least one of the plurality of interfaces which is determined to have been provided to the apparatus, and

wherein the connection selection section comprises a presenting division presenting to the user the selection support information to inform the user that it is recommended that the user specify at least one of the plurality of interfaces which is determined to have been provided to the device.

The apparatus according to the above mode (18) provides the same functions and effects as the process according to the above mode (4), and various changes and modifications may be made in the apparatus without departing from its spirit, similarly to the process according to the above mode (4).

(19) The apparatus according to any one of modes (15)-(18), further comprising a defining section defining the selection support information based on the recognized interface availability, and wherein the connection selection section comprises a presenting division presenting to the user the defined selection support information, thereby allowing the user to specify one of the plurality of interfaces in conformity with the recognized interface availability.

The apparatus according to the above mode (19) provides the same functions and effects as the process according to the above mode (5), and various changes and modifications may be made in the apparatus without departing from its spirit, similarly to the process according to the above mode (5).

(20) The apparatus according to mode (19), wherein the defining section comprises a defining division defining the selection support information in conformity with the recognized interface availability, and in conformity with pre-established priority for operation between the plurality of interfaces.

The apparatus according to the above mode (20) provides the same functions and effects as the process according to the above mode (6), and various changes and modifications may be made in the apparatus without departing from its spirit, similarly to the process according to the above mode (6).

(21) The apparatus according to mode (20), wherein the priority is pre-established to be varied depending on a kind of one of the plurality of device drivers which is to be installed.

The apparatus according to the above mode (21) provides the same functions and effects as the process according to the above mode (7), and various changes and modifications may be made in the apparatus without departing from its spirit, similarly to the process according to the above mode (7).

(22) The apparatus according to mode (20) or (21), further comprising an environment selection section allowing the user to specify an operating environment in which the apparatus operates, and

wherein the priority is pre-established to be varied depending on a kind of the specified operating environment.

The apparatus according to the above mode (22) provides the same functions and effects as the process according to the above mode (8), and various changes and modifications may be made in the apparatus without departing from its spirit, similarly to the process according to the above mode (8).

(23) The apparatus according to mode (22), wherein the operating environment is selected from a stand-alone environment in which the apparatus is communicated with the device without intervention of any network, and a network environment in which the apparatus is communicated with the device via a network.

The apparatus according to the above mode (23) provides the same functions and effects as the process according to the above mode (9), and various changes and modifications may be made in the apparatus without departing from its spirit, similarly to the process according to the above mode (9).

(24) The apparatus according to any one of modes (15)-(23), further comprising:

a storage for storing information; and

a storing section storing in the storage, information for identifying one of the plurality of interfaces which corresponds to one of the plurality of device drivers which has been installed within the apparatus, and

wherein the connection selection section comprises a presenting division, after the one device driver has been installed within the apparatus, prior to another event of installation, presenting to the user the selection support information to inform the user that it is recommended that the user specify the interface identified by the information stored in the storage.

The apparatus according to the above mode (24) provides the same functions and effects as the process according to the above mode (10), and various changes and modifications may be made in the apparatus without departing from its spirit, similarly to the process according to the above mode (10).

Several presently preferred embodiments will be described in detail by reference to the drawings in which like numerals are used to indicate like elements throughout.

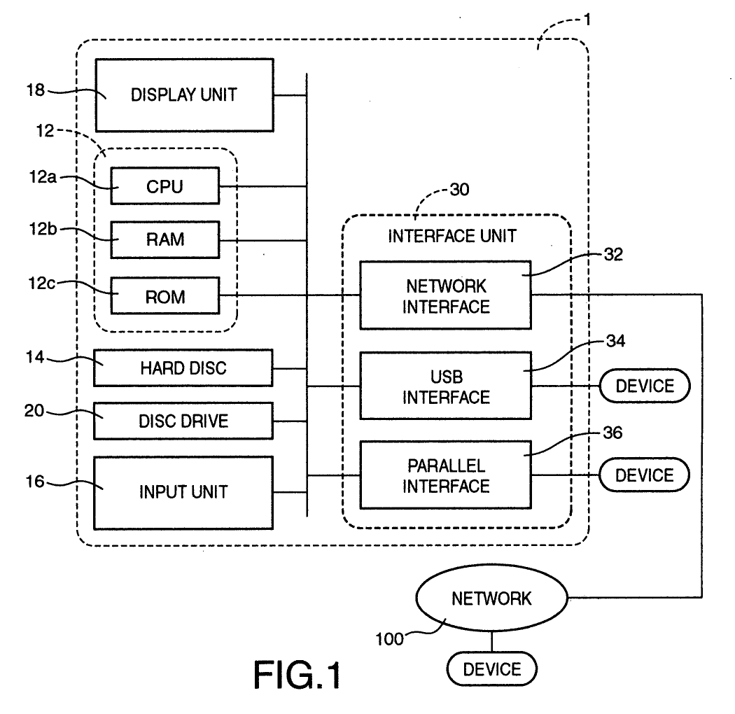

Referring now to FIG. 1, a personal computer (hereinafter, abbreviated as “PC”) 1 according to a first embodiment of the present invention is schematically illustrated in block diagram. As illustrated, the PC 1 includes a controller 12 incorporating a CPU 12a, a RAM 12b, a ROM 12c, buses, etc. The controller 12 can be alternatively referred to as a computer because the controller 12 incorporates a processor and a memory interconnected therewith and plays a major role in the PC 1.

The PC 1 further includes a hard disc 14 as an example of a storage, an input unit 16 in the form of a keyboard, a mouse, etc. as not illustrated, and a display unit 18 in the form of an LCD, for example. The PC 1 still further includes a disc drive 20 adapted to retrieve data from a removable disc (a CD-ROM, etc., in the present embodiment), and an interface unit 30 for control of data communication between the PC 1 and external devices.

The interface unit 30 includes a network interface 32 for connecting the PC 1 to a network (a LAN (Local-Area Network), in the present embodiment) 100, a USB (Universal Serial Bus) interface 34 for connecting devices conforming with a USB standard, to the PC 1 via a USB cable, and a parallel interface 36 for connecting a device primarily functioning as a printer, to PC 1 via a parallel cable.

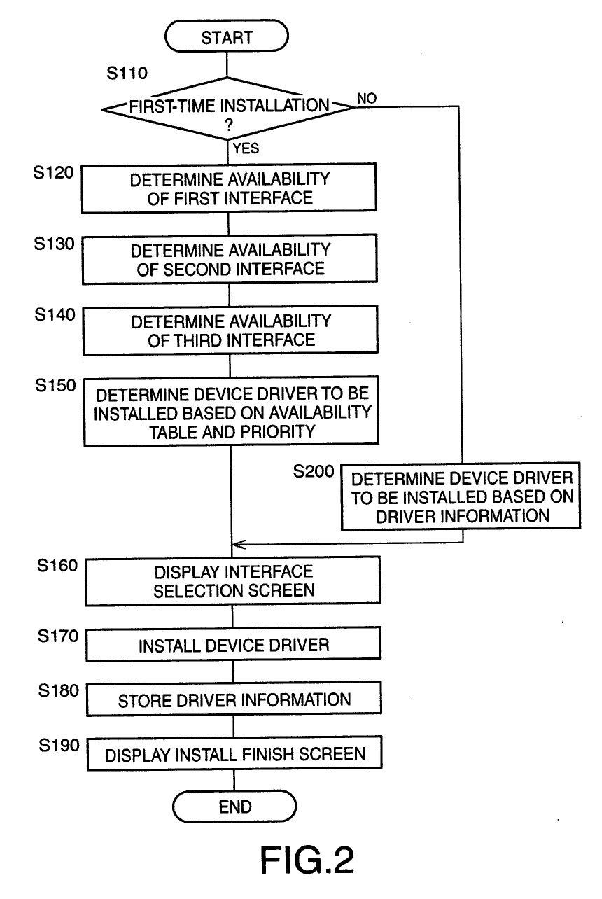

Referring next to FIG. 2, there will be described an installation procedure in accordance with which a device driver (software application) for controlling the aforementioned device is installed in the PC 1 itself.

For implementing the installation procedure, the controller 12 executes an install program which has been stored in the aforementioned disc, from which data is retrieved via the disc drive 20. FIG. 2 schematically illustrates the install program in flow chart.

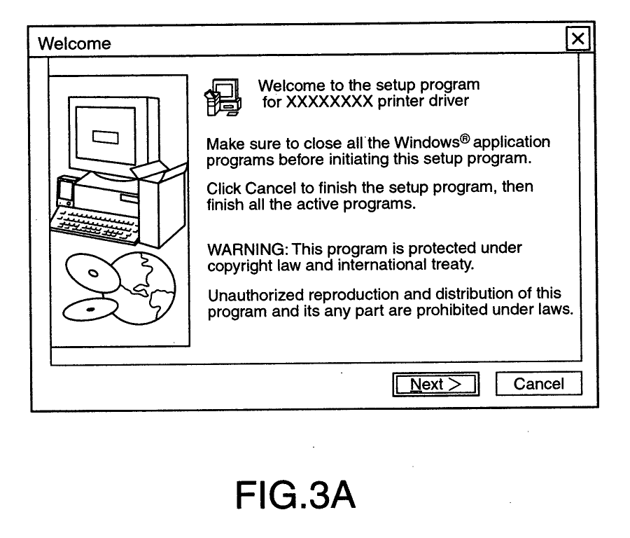

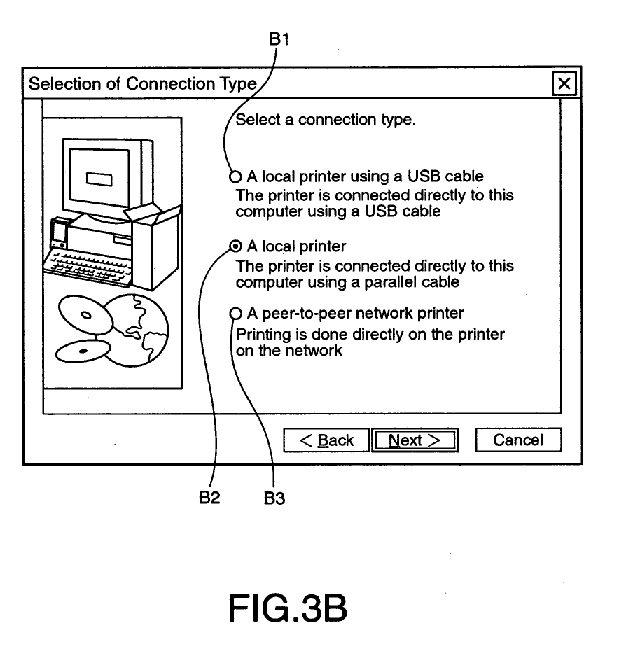

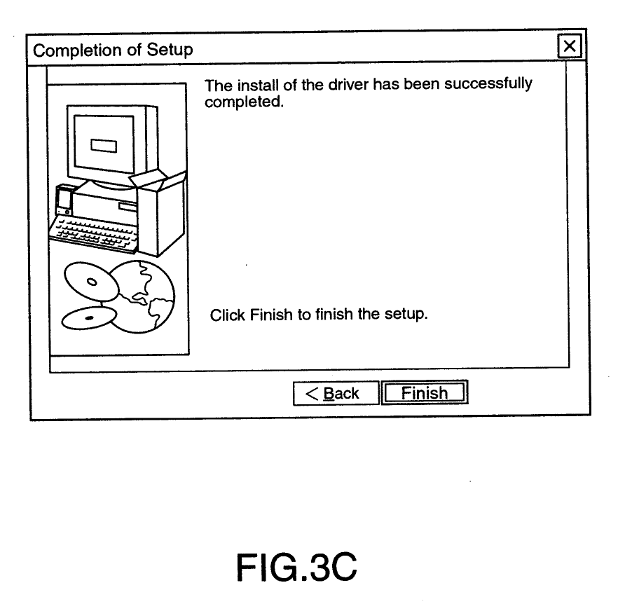

Once the aforementioned disc is mounted in the disc drive 20, the install program is initiated to cause the display unit 18 to display an install initiation screen. FIG. 3A illustrates an example of such an install initiation screen.

If a user performs an action for verification via the input unit 16 according to the install initiation screen (selects or clicks on a “NEXT” button illustrated in FIG. 3A, in the present embodiment), then the installation procedure is initiated.

It is added that, although the install program is directly transferred from the disc into the PC 1 in the present embodiment, it is of course that the present invention may be alternatively practiced such that, for example, the install program is transferred into the PC 1 from a remote device, a storage medium, etc., which are connected with the PC 1 via the interface unit 30.

Upon execution of the install program by the controller 12, the install program is initiated with a step S110 illustrated in FIG. 2 to make a determination as to whether or not the current cycle of execution of the install program is for installing a device driver for the first time.

The install program is configured so as to install a device driver in the PC 1 in a step S170 described later, and then to store in a registry 50 which is a particularly-allocated storage area in the hard disc 14 in a step 180 described later, driver information including information (an ID code of a device, in the present embodiment) for identifying a device operable under the device driver which has been installed.

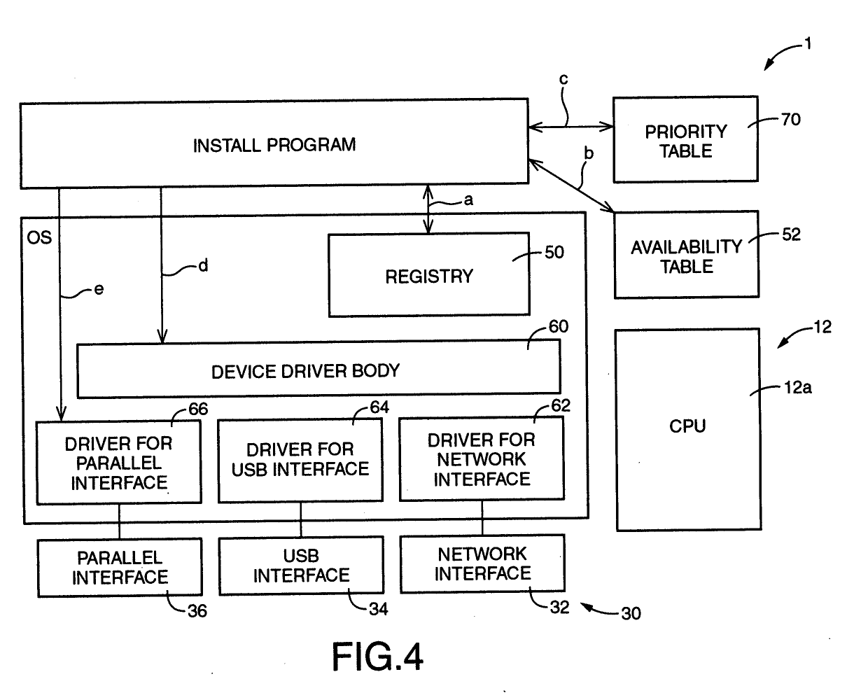

For the above reasons, the step S110 is implemented to refer to the registry 50 for storage of the driver information, as depicted by the arrow “a” in FIG. 4. If no driver information has been stored in the registry 50, or if a device identified by the driver information stored in the registry 50 is not identical to a device operable under a device driver which will be installed as a result of the execution of the install program, then it is determined in the step S110 that the current cycle of execution of the install program is for installing a device driver for the first time.

If it is determined in the step S110 that the current cycle of execution of the install program is for installing a device driver for the first time, then the determination of the step S110 becomes affirmative “YES.” Thereafter, the install program proceeds to a step S120.

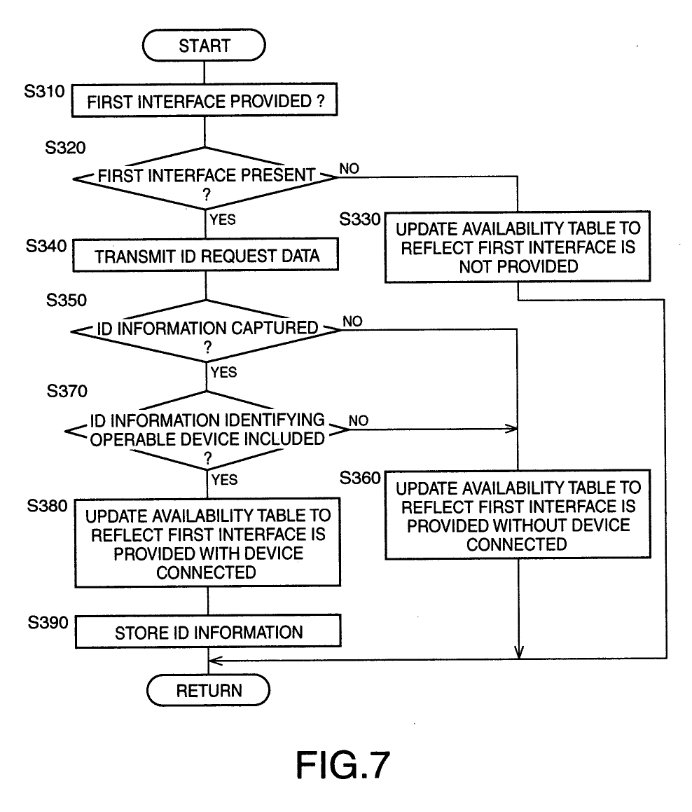

As described in more detail with reference to FIG. 7, the step S120 is implemented to determine or verify whether or not a first interface is available to the PC 1, to thereby recognize the interface availability (or the status-of-use of interface) with respect to the first interface.

More specifically, the step S120 is implemented to determine whether or not the PC 1 has been provided with the network interface 32 as an example of the first interface. The step S120 is further implemented to determine whether or not the PC 1 has been connected via the network interface 32, to a device operable under a device driver which will be installed as a result of execution of the install program.

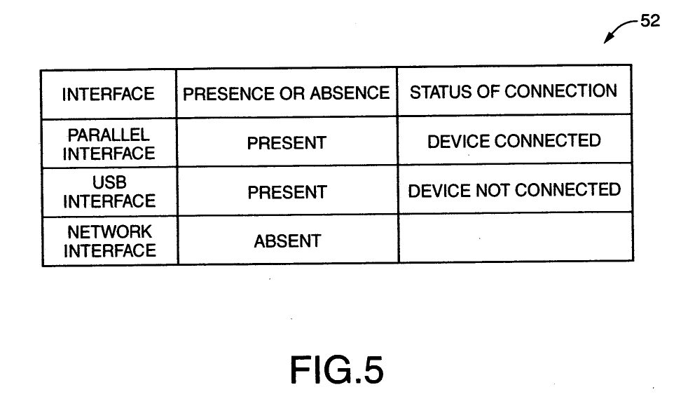

These determination results, that is, the presence/absence of the network interface 32 and the status of connection between the network interface 32 and a particular device (operable device) are entered into an availability table 52 (see FIGS. 4 and 5) which has been assigned to the RAM 12b built in the controller 12.

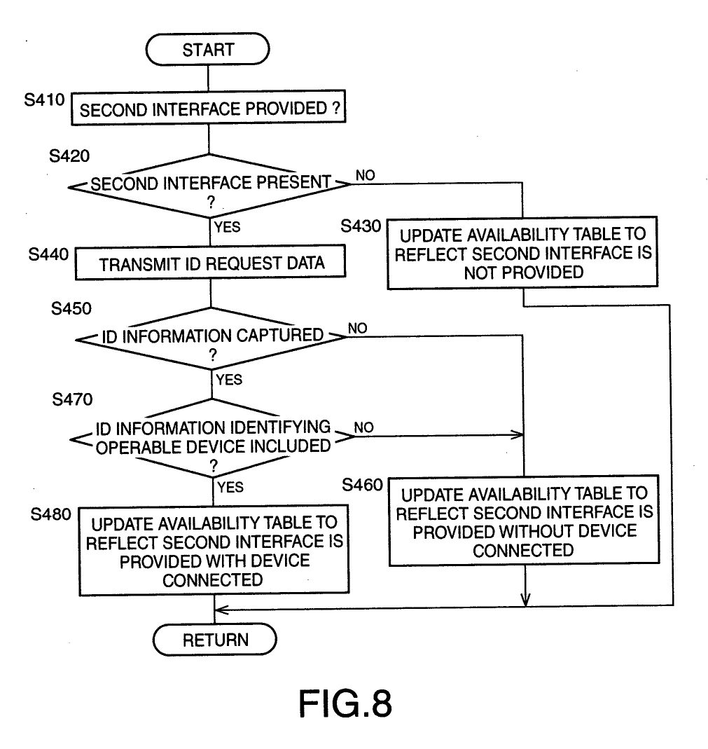

Thereafter, a step S130 is implemented to determine the availability of a second interface, as described in more detail with reference to FIG. 8.

More specifically, the step S130 is implemented to determine whether or not the PC 1 has been provided with the USB interface 34 as an example of the second interface. The step S130 is further implemented to determine whether or not the PC 1 has been connected via the USB interface 34, to a device operable under a device driver which will be installed as a result of execution of the install program.

These determination results, that is, the presence/absence of the USB interface 34 and the status of connection between the USB interface 34 and a particular device (operable device) are entered into the availability table 52 (see FIGS. 4 and 5), which has been assigned to the RAM 12b built in the controller 12.

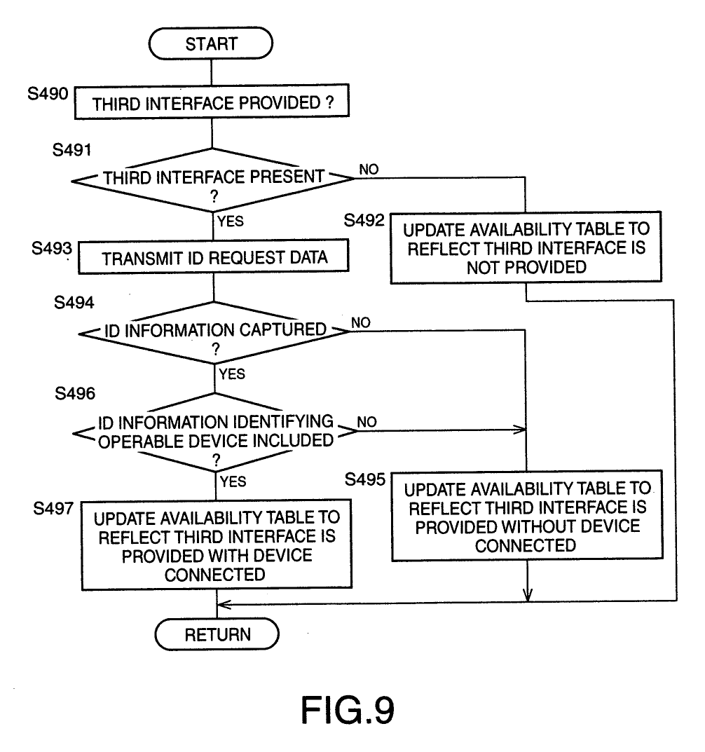

Thereafter, a step S140 is implemented to determine the availability of a third interface, as described in more detail with reference to FIG. 9.

More specifically, the step S140 is implemented to determine whether or not the PC 1 has been provided with the parallel interface 36 as an example of the third interface. The step S140 is further implemented to determine whether or not the PC 1 has been connected via the parallel interface 36, to a device operable under a device driver which will be installed as a result of execution of the install program.

These determination results, that is, the presence/absence of the parallel interface 36 and the status of connection between the parallel interface 36 and a particular device (operable device) are entered into the availability table 52 (see FIGS. 4 and 5), which has been assigned to the RAM 12b built in the controller 12.

Thereafter, a step S150 is implemented to determine one of a plurality of interfaces 32, 34, 36 different in kind, to which a device driver to be appropriately installed in the PC 1 corresponds, based on the content of the availability table 52, and a pre-established priority for operation between these interfaces 32, 34, 36.

As schematically illustrated in FIG. 4, the aforementioned disc, which has stored therein the install program, has also stored therein device drivers in the form of two modules, one of which is a device driver body 60 for control of a particular device, the other of which is a set of per-interface drivers 62, 64, 66 for data communication between the device driver body 60 and the particular device in a fashion meeting the standard of a selected one of the interfaces 32, 34, 36.

The per-interface drivers 62, 64, 66, which correspond to the plurality of interfaces 32, 34, 36, are combined commonly with the device driver body 60 to form a plurality of device drivers (three device drivers, in the present embodiment) different in kind which correspond to the plurality of interfaces 32, 34, 36, respectively.

The step S150 illustrated in FIG. 2 is implemented to determine an appropriate one of the plurality of device drivers to be installed in the PC 1.

More specifically, to begin with, the availability table 52 is referred to, as depicted by the arrow “b” in FIG. 4. If the availability table 52 has stored therein information indicating that there exists an interface (see FIG. 5 for reference to “parallel interface”) with which the PC 1 has been provided, and which has been connected to a device operable under a device driver to be installed, then it is determined that the device driver corresponding to the interface is to be installed. There is stored in the RAM 12b built in the controller 12, interface information for identifying the interface corresponding to the device driver.

On the other hand, if it is determined or verified that there exist a plurality of interfaces, with each of which the PC 1 has been provided, and each of which has been connected to a device operable under a device driver to be installed, then it is determined that a device driver corresponding to one of the interfaces highest in priority is to be installed. The interface information is stored in the RAM 12b so as to reflect the determination result.

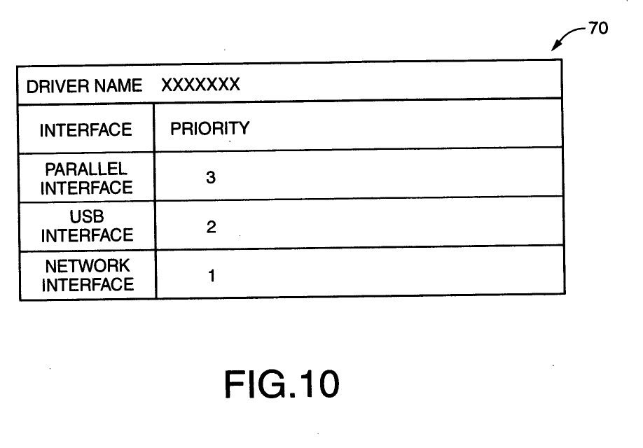

In the present embodiment, as illustrated in FIG. 4, a priority table 70 representative of the priority of the interfaces 32, 34, 36 has been also stored in the aforementioned disc. The priority table 70 indicates that the network interface 32 is first in order, the USB interface 34 is second in order, and the parallel interface 36 is third in order, as illustrated in FIG. 10.

The reference to the priority table 70 (see FIG. 4 for the arrow “c”) allows one of a plurality of available interfaces which is the highest in priority to be selected.

The content of the priority table 70 may be retrieved, for example, by a direct access to the aforementioned disc, may be stored from the disc into the RAM 12b or the hard disc 14 and then retrieved therefrom, may be copied from the disc into the registry 50 and retrieved therefrom, or may be retrieved in alternative manners.

If it is determined or verified that there exists no interface, with which the PC 1 has been provided, and which has been connected to a device operable under a device driver to be installed, then it is determined that a device driver corresponding to an interface with which it is determined that the PC 1 has been provided, is to be installed. The interface information is stored in the RAM 12b so as to reflect the determination result.

In the above case, if it is determined or verified that there exist a plurality of interfaces, with each of which the PC 1 has been provided, but each of which has not been connected to a device operable under a device driver to be installed, then it is determined that a device driver corresponding to one of the interfaces highest in priority is to be installed, in a manner described above, as well.

On the other hand, if all the existing interfaces are determined or verified not to have been provided to the PC 1, then it is determined that a device driver corresponding to one of the existing interfaces highest in priority is to be installed, in a manner described above, as well.

It is added that the present invention may be practiced in a manner in which, prior to making a determination as to which device driver to install, the user is caused to verify whether or not the user requests installation of a particular device driver by alerting the user through a message box, for example, and then the determination as to which device driver to install is made, provided that the user performs an action indicative of a request of installation via the input unit 16.

Once the device driver to be installed has been determined in the step S150 in a manner described above, a step S160 is implemented to cause the display unit 18 to display an interface selection screen for allowing the user to select or specify one of a plurality of interfaces.

The interface selection screen is displayed for presenting to the user, selection support information for supporting the user to specify one of a plurality of interfaces different in kind. A displayed manner in which the interface selection screen is displayed on the display unit 18 is varied with changes in the kind of a device driver to be installed. As a result, the content of the selection support information to be presented to the user through the interface selection screen is varied with changes in the kind of a device driver to be installed.

FIG. 3B illustrates an example of the interface selection screen. For this example, there are displayed on an image screen of the display unit 18, a plurality of radio buttons corresponding to a plurality of connection types different in kind, each of which is for communication between the PC 1 and the particular device which will become operable under a device driver upon installation. As is well known in the art, these radio buttons are virtual buttons, one of which is to be selected by the user for selecting one of a plurality of options.

The user is allowed to select one of the plurality of radio buttons through the user action via the input unit 16 (for example, mouse click of the user). Selection of one radio button leads to selection of one connection type corresponding to the selected one radio button.

In the present embodiment, the display of the interface selection screen is initiated to indicate that one of the plurality of radio buttons is already picked (turned on). A connection type corresponding to the initially-picked radio button corresponds to the aforementioned interface information stored in the RAM 12b by the implementation of the step S150.

More specifically, in the present embodiment, as illustrated in FIG. 3B, there is provided in the interface selection screen, three radio buttons corresponding to a connection type under the USB interface 34, a connection type under the parallel interface 36, and a connection type under the network interface 32, respectively.

If the interface information indicates the USB interface 34, then a radio button B1 (labeled “local printer using USB cable” in FIG. 3B) corresponding to the connection type under the USB interface 34 is initially displayed in a picked state. If the interface information indicates the parallel interface 36, then a radio button B2 (labeled “local printer” in FIG. 3B) corresponding to the connection type under the parallel interface 36 is initially displayed in a picked state. If the interface information indicates the network interface 32, then a radio button B3 (labeled “peer-to-peer network printer” in FIG. 3B) corresponding to the connection type under the network interface 32 is initially displayed in a picked state.

In the interface selection screen illustrated in FIG. 3B, the radio button B2 corresponding to the connection type under the parallel interface 36 is initially displayed in a picked state.

As will be evident from the above explanation, the interface selection is displayed on the display unit 18 in a display manner allowing the user to notify that a device driver corresponding to the kind of an interface indicated by the aforementioned interface information is to be installed in the PC 1.

If the user, after the interface selection screen is initiated to be displayed on the display unit 18, performs via the input unit 16 an action indicating that the user verified the content of the interface selection screen (clicks on the “NEXT” button in FIG. 3B, for example), without re-selecting the radio buttons via the input unit 16, then there is specified the interface using the connection type corresponding to the radio button which has been displayed in a picked state since the initiation of the display of the interface selection screen. Further, the device driver corresponding to the specified interface is specified as one to be installed in the PC 1.

In contrast, if the user, after re-selecting the radio buttons via the input unit 16, performs via the input unit 16 an action indicating that the user verified the content of the interface selection screen (clicks on the “NEXT” button in FIG. 3B, for example), then there is specified the interface using the connection type corresponding to the radio button which has been newly picked by the user. Further, the device driver corresponding to the specified interface is specified as one to be installed in the PC 1.

In any way, the step S160 is followed by a step S170 to install in the PC 1, the device driver specified by the user in the above manner. More specifically, as depicted by the arrows “d” and “e,” the device driver is stored in a particularly-assigned storage area of the hard disc 14.

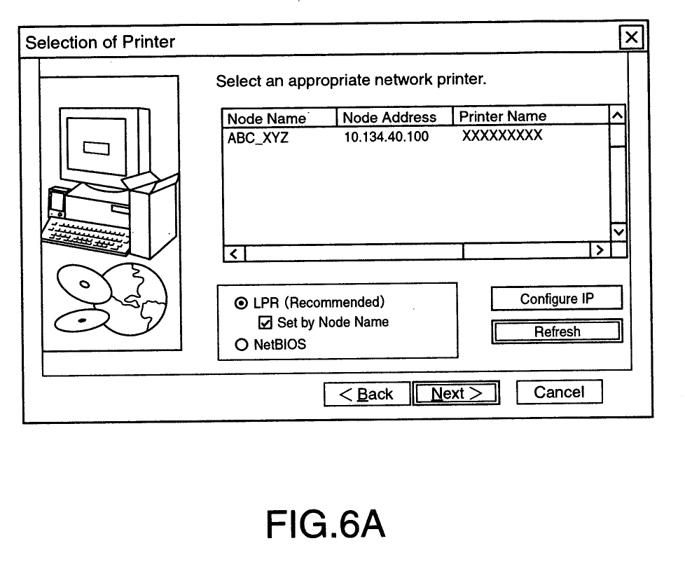

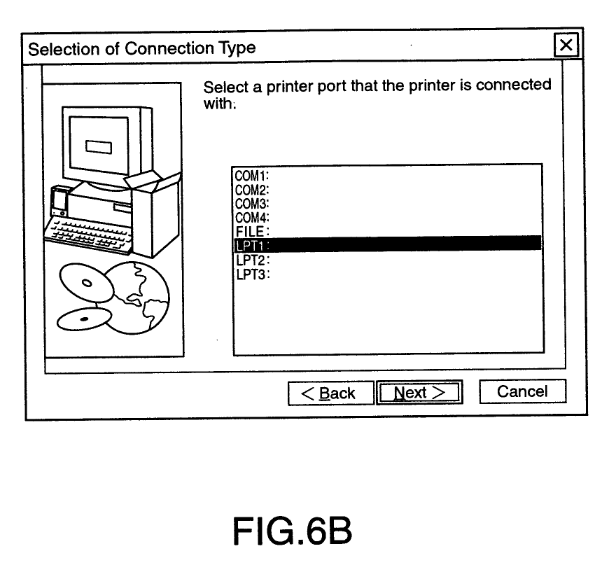

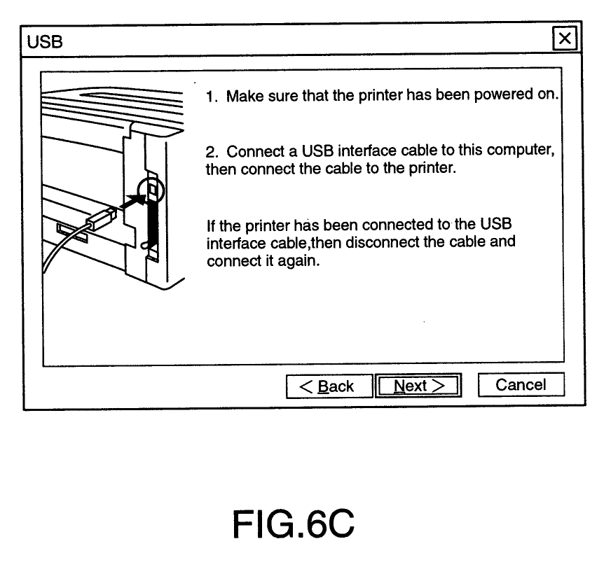

Still more specifically, if the network interface 32 corresponds to the device driver specified by the user through the interface selection screen, then the specified device driver is installed, after the user specifies a particular device through a device selection screen for allowing a device selection, as exemplary illustrated in FIG. 6A.

On the other hand, if the parallel interface 36 corresponds to the device driver specified by the user through the interface selection screen, then the specified device driver is installed, after the user specifies a particular port through a port selection screen for allowing a port selection, as exemplary illustrated in FIG. 6B.

It is added that the display step of the device selection screen may be removed when the RAM 12b has stored therein information indicating that only one device can be specified, as described later.

The step S170 is implemented to install a set of the device driver body and a selected one of the per-interface drivers, as a device driver specified by the user.

More specifically, if a device driver corresponding to an interface different from the currently-specified interface was installed as a result of a previous execution of the install program prior to the current implementation of installation, the device driver body is not installed during the current implementation of installation, while only the corresponding per-interface driver is installed. FIG. 4 illustrates the PC 1 with all the per-interface drivers with which the PC 1 has been provided, being installed.

The step S170 is followed by a step S180 illustrated in FIG. 2 to define the aforementioned driver information. More specifically, the driver information is defined so as to include information (ID code) for identifying a device operable under a device driver which has been installed as a result of the implementation of the step S170, and information representative of one of a plurality of interfaces that corresponds to the installed device driver.

The step S180 is further implemented to store the defined driver information in the registry 50 built in the hard disc 14, as depicted by the arrow “a” in FIG. 4.

Thereafter, a step S190 illustrated in FIG. 2 is implemented to cause the display unit 18 to display an install finish screen exemplary illustrated in FIG. 3C. After the user, while viewing the install finish screen, performs via the input unit 16 an action for verifying the content of the install finish screen (clicks on a “finish” button in FIG. 3C), one cycle of execution of the install program is terminated.

Although the install program has been described above for the case where the current cycle of execution of the install program is for installing a device driver for the first time, and therefore the determination of the step S110 is affirmative “YES,” if the determination is negative “NO,” then the install program proceeds to a step S200.

The step S200 is implemented to determine which one of a plurality of interfaces corresponds to one of a plurality of device drivers that is appropriately installed in the PC 1, based on the driver information stored in the registry 50 of the hard disc 14.

More specifically, one of the interfaces that corresponds to the installed device driver is identified based on the driver information stored in the registry 50 of the hard disc 14. It is then determined that the device driver corresponding to the identified interface is to be installed.

The step S200 is further implemented to re-define the driver information so as to reflect information of the interface corresponding to the device driver determined to be installed. The registry 50 is updated so as to reflect the content of the re-defined driver information.

Upon termination of implementation of the step S200, the above-described steps S160-190 are implemented similarly. More specifically, the step S160 is implemented to display the interface selection screen in a display manner conforming with the determination result of the step S200.

Thereafter, the step S170 is implemented to install the corresponding device driver, and the step S180 is subsequently implemented to over-write the registry 50 to reflect the newest driver information.

Then, one cycle of execution of the install program is terminated.

Referring next to FIG. 7, the step S120 illustrated in FIG. 2 will be described in more detail. FIG. 7 schematically illustrates in flow chart the detailed content of the step S120 in the name of a first status check routine.

Upon initiation of the first status check routine, a step S310 is firstly implemented to determine whether or not the PC 1 has been provided with the first interface. More specifically, a determination is made as to whether or not the PC 1 has been provided with the network interface 32 as an example of the first interface, owing to a function (an API (Application Programming Interface), in the present embodiment) of an OS (Operating System) which has been installed within the PC 1.

Next, a step S320 is implemented to make a determination as to whether or not the first interface was determined in the step S310 to have been provided to the PC 1. If the first interface was not determined in the step S310 to have been provided to the PC 1,.then the determination of the step S320 becomes negative “NO,” and the first status check routine proceeds to a step S330.

The step S330 is implemented to enter data into the availability table 52 assigned to the RAM 12b built in the controller 12, which indicates that the first interface (the network interface 32, in the present embodiment) has not been provided to the PC 1. For example, as illustrated in FIG. 5, the availability table 52 is updated to reflect the content that the network interface 32 is absent.

It is added that a case exists where the availability table 52 is not created in the RAM 12b prior to the implementation of the step S330. In this case, information indicative of the presence/absence of the first interface is entered into the availability table 52 after its creation.

Then, one cycle of execution of the first status check routine is terminated, and subsequently, the install program proceeds to the step S130 illustrated in FIG. 2.

If it is determined by the implementation of the step S310, that the first interface has been provided to the PC 1, then the determination of the step S320 becomes affirmative “YES,” and the first status check routine proceeds to a step S340.

The step S340 is implemented to transmit ID request data via the existing first interface, for requesting ID information (ID codes of devices, and node names, in the present embodiment) usable for identifying devices.

More specifically, the ID request data is broadcast from the network interface 32 toward the network 100. If the network interface 32 has been connected with the network 100, and if there exists at least one device (a plurality of devices, typically) enable on the network 100, then each of these devices responds to a request represented by the ID request data, by sending device ID data capable of identifying the ID information of each device, to the PC 1.

Thereafter, a step S350 is implemented to determine whether or not the ID information was captured before a predetermined length of time (for example, 5 seconds, in the present embodiment) elapsed since the transmission of the ID request data was initiated as a result of the implementation of the step S340.

The present embodiment is configured such that, once the device ID data is received via the network interface 32 after the transmission of the ID request data by the implementation of the step S340, a plurality of pieces of ID information (a set of an ID code, a node name, and address information (a sender IP address of device ID data, in the present embodiment)) are sequentially stored in the RAM 12b built in the controller 12.

As a result, in the step S350, if one or more pieces of ID information are stored in the RAM 12b before the predetermined length of time (e.g., 5 seconds) elapses since the ID request data was transmitted, then it is determined that at least one piece of ID information was captured.

If no ID information is captured within the predetermined length of time, then the determination of the step S350 becomes negative “NO,” and the first status check routine proceeds to a step S360.

The step S360 is implemented to enter data into the availability table 52, which indicates that the first interface has been provided to the PC 1, but any device has not been connected with the first interface.

It is added that, if the availability table 52 is not created in the RAM 12b prior to the implementation of the step S340, information indicative of the presence/absence of the first interface and status of connection with devices is entered into the availability table 52 after its creation, similarly to the above.

Then, one cycle of execution of the first status check routine is terminated, and subsequently, the install program proceeds to the step S130 illustrated in FIG. 2.

On the other hand, if at least one piece of ID information is captured within the predetermined length of time, then the determination of the step S350 becomes affirmative “YES,” and the first status check routine proceeds to a step S370.

The step S370 is implemented to make a determination as to whether or not the thus-captured ID information contains a piece of ID information indicating that the currently-connected device is a device (hereinafter, referred to as “operable device”) operable under a device driver which will be installed by the execution of the install program.

If the captured-ID information does not contain a piece of ID information indicating that the currently-connected device is an operable device, then the determination of the step S370 becomes negative “NO,” and the first status check routine proceeds to the step S360.

As described above, the step S360 is implemented to enter data into the availability table 52, which indicates that the first interface has been provided to the PC 1, but any device has not been connected with the first interface.

Then, one cycle of execution of the first status check routine is terminated, and subsequently, the install program proceeds to the step S130 illustrated in FIG. 2.

On the other hand, if the captured-ID information contains a piece of ID information indicating that the currently-connected device is an operable device, then the determination of the step S370 becomes affirmative “YES,” and the first status check routine proceeds to a step S380.

The step S380 is implemented to enter data into the availability table 52, which indicates that the first interface has been provided to the PC 1, and an operable device has been connected with the first interface. For example, as illustrated in FIG. 5, the availability table 52 is updated to reflect the content that the network interface 32 is present, and a device has been connected with the network interface 32.

If there exists in the RAM 12b information which was received after the ID request data was transmitted by the implementation of the step S340, and if the existing information contains at least one piece of ID information (a plurality of pieces of ID information, typically) indicating that the currently-connected device is an operable device, then a step S390 illustrated in FIG. 7 is implemented to store these pieces of ID information, respectively, in the RAM 12b.

Each of these pieces of ID information stored in the RAM 12b in the step S390 is utilized for displaying, on the device selection screen (see FIG. 6A) displayed by the implementation of the step S170 illustrated in FIG. 2, the kind of a device to be specified by the user, for information of the user.

Then, one cycle of execution of the first status check routine is terminated, and subsequently, the install program proceeds to the step S130 illustrated in FIG. 2.

Referring next to FIG. 8, the step S130 illustrated in FIG. 2 will be described in more detail. FIG. 8 schematically illustrates in flow chart the detailed content of the step S130 in the name of a second status check routine. The second status check routine, because being basically in common in content to the first status check routine illustrated in FIG. 7, will be described briefly without a redundant explanation.

Upon initiation of the second status check routine, a step 410 is firstly implemented to determine whether or not the PC 1 has been provided with the second interface. More specifically, similarly to the step S310, a determination is made as to whether or not the PC 1 has been provided with the USB interface 34 as an example of the second interface, owing to the function (the API) of the OS which has been installed within the PC 1.

Next, a step S420 is implemented to make a determination as to whether or not the second interface was determined in the step S410 to have been provided to the PC 1. If the second interface was not determined in the step S410 to have been provided to the PC 1, then the determination of the step S420 becomes negative “NO,” and the second status check routine proceeds to a step S430.

The step S430 is implemented, similarly to the step S330 illustrated in FIG. 7, to enter data into the availability table 52 assigned to the RAM 12b built in the controller 12, which indicates that the second interface (the USB interface 34, in the present embodiment) has not been provided to the PC 1.

Then, one cycle of execution of the second status check routine is terminated, and subsequently, the install program proceeds to the step S140 illustrated in FIG. 2.

If it is determined by the implementation of the step S410, that the second interface has been provided to the PC 1, then the determination of the step S420 becomes affirmative “YES,” and the second status check routine proceeds to a step S440.

The step S440 is implemented to transmit the ID request data via the existing second interface, for requesting the ID information usable for identifying devices.

More specifically, the ID request data for requesting the ID information (ID codes, in the present embodiment) is transmitted from the USB interface 34. If a device has been connected with the USB interface 34, then the device responds to a request represented by the ID request data, by sending the device ID data capable of identifying the ID information of the device, to the PC 1.

It is added that, where the OS is configured to allow the ID code of a device connected with the USB interface 34, to be captured owing to the aforementioned function (API), the second status check routine may be modified so as to directly capture the ID information of a device by using the function, instead of by requesting the ID code using the ID request data.

It is further added that the second status check routine may be modified so as to cause the display unit 18 to display, prior to the transmission of the ID request data, a connection verification screen such as illustrated in FIG. 6C, for thereby allowing the user to verify that a device connected with the USB interface 34 has an active state, or prompting the user to connect a device with the USB interface 34.

The step S440 is followed by a step S450 to determine whether or not the ID information was captured before the predetermined length of time elapsed since the transmission of the ID request data was initiated as a result of the implementation of the step S440.

The present embodiment is configured such that, once the device ID data is received via the USB interface 34 after the transmission of the ID request data by the implementation of the step S440, the ID information identified by the received device ID data is stored in the RAM 12b.

As a result, in the step S450, if the ID information is stored in the RAM 12b before the predetermined length of time elapses since the ID request data was transmitted, then it is determined that the ID information was captured.

If no ID information is captured within the predetermined length of time, then the determination of the step S450 becomes negative “NO,” and the second status check routine proceeds to a step S460.

The step S460 is implemented to enter data into the availability table 52, which indicates that the second interface has been provided to the PC 1, but any device has not been connected with the second interface. For example, as illustrated in FIG. 5, the availability table 52 is updated to reflect the content that the USB interface 34 is present, but any device has not been connected with the USB interface 34.

Then, one cycle of execution of the second status check routine is terminated, and subsequently, the install program proceeds to the step S140 illustrated in FIG. 2.

On the other hand, if the ID information is captured within the predetermined length of time, then the determination of the step S450 becomes affirmative “YES,” and the second status check routine proceeds to a step S470.

The step S470 is implemented to make a determination as to whether or not the thus-captured ID information contains a piece of ID information indicating that the currently-connected device is an operable device described above.

If the captured-ID information does not contain a piece of ID information indicating that the currently-connected device is an operable device, then the determination of the step S470 becomes negative “NO,” and the second status check routine proceeds to the step S460.

As described above, the step S460 is implemented to enter data into the availability table 52, which indicates that the second interface has been provided to the PC 1, but any device has not been connected with the second interface.

Then, one cycle of execution of the second status check routine is terminated, and subsequently, the install program proceeds to the step S140 illustrated in FIG. 2.

On the other hand, if the captured-ID information contains a piece of ID information indicating that the currently-connected device is an operable device, then the determination of the step S470 becomes affirmative “YES,” and the second status check routine proceeds to a step S480.

The step S480 is implemented to enter data into the availability table 52, which indicates that the second interface has been provided to the PC 1, and an operable device has been connected with the second interface.

Then, one cycle of execution of the second status check routine is terminated, and subsequently, the install program proceeds to the step S140 illustrated in FIG. 2.

Referring next to FIG. 9, the step S140 illustrated in FIG. 2 will be described in more detail. FIG. 9 schematically illustrates in flow chart the detailed content of the step S140 in the name of a third status check routine. The third status check routine, because being basically in common in content to the second status check routine illustrated in FIG. 8, will be described briefly without a redundant explanation.

Upon initiation of the third status check routine, a step S490 is firstly implemented to determine whether or not the PC 1 has been provided with the third interface. More specifically, similarly to the step S410, a determination is made as to whether or not the PC 1 has been provided with the parallel interface 36 as an example of the third interface, owing to the function (the API) of the OS which has been installed within the PC 1.

Next, a step S491 is implemented to make a determination as to whether or not the third interface was determined in the step S490 to have been provided to the PC 1. If the third interface was not determined in the step S490 to have been provided to the PC 1, then the determination of the step S491 becomes negative “NO,” and the third status check routine proceeds to a step S492.

The step S492 is implemented, similarly to the step S430 illustrated in FIG. 8, to enter data into the availability table 52 assigned to the RAM 12b built in the controller 12, which indicates that the third interface (the parallel interface 36, in the present embodiment) has not been provided to the PC 1.

Then, one cycle of execution of the third status check routine is terminated, and subsequently, the install program proceeds to the step S150 illustrated in FIG. 2.

If it is determined by the implementation of the step S490, that the third interface has been provided to the PC 1, then the determination of the step S491 becomes affirmative “YES,” and the third status check routine proceeds to a step S493.

The step S493 is implemented to transmit the ID request data via the existing third interface, for requesting the ID information usable for identifying devices.

More specifically, the ID request data for requesting the ID information (ID codes, in the present embodiment) is transmitted from the parallel interface 36. If a device has been connected with the parallel interface 36, then the device responds to a request represented by the ID request data, by sending the device ID data capable of identifying the ID information of the device, to the PC 1.

It is added that, where the OS is configured to allow the ID code of a device connected with the parallel interface 36, to be captured owing to the aforementioned function (API), the third status check routine may be modified so as to directly capture the ID information of a device by using the function, instead of by requesting the ID code using the ID request data.

The step S493 is followed by a step S494 to determine whether or not the ID information was captured before the predetermined length of time elapsed since the transmission of the ID request data was initiated as a result of the implementation of the step S493.

The present embodiment is configured such that, once the device ID data is received via the parallel interface 36 after the transmission of the ID request data by the implementation of the step S493, the ID information identified by the received device ID data is stored in the RAM 12b.

As a result, in the step S494, if the ID information is stored in the RAM 12b before the predetermined length of time elapses since the ID request data was transmitted, then it is determined that the ID information was captured.

If no ID information is captured within the predetermined length of time, then the determination of the step S494 becomes negative “NO,” and the third status check routine proceeds to a step S495.

The step S495 is implemented to enter data into the availability table 52, which indicates that the third interface has been provided to the PC 1, but any device has not been connected with the third interface.

Then, one cycle of execution of the third status check routine is terminated, and subsequently, the install program proceeds to the step S150 illustrated in FIG. 2.

On the other hand, if the ID information is captured within the predetermined length of time, then the determination of the step S494 becomes affirmative “YES,” and the third status check routine proceeds to a step S496.

The step S496 is implemented to make a determination as to whether or not the thus-captured ID information contains a piece of ID information indicating that the currently-connected device is an operable device described above.

If the captured-ID information does not contain a piece of ID information indicating that the currently-connected device is an operable device, then the determination of the step S496 becomes negative “NO,” and the third status check routine proceeds to the step S495.

As described above, the step S495 is implemented to enter data into the availability table 52, which indicates that the third interface has been provided to the PC 1, but any device has not been connected with the third interface.

Then, one cycle of execution of the third status check routine is terminated, and subsequently, the install program proceeds to the step S150 illustrated in FIG. 2.

On the other hand, if the captured-ID information contains a piece of ID information indicating that the currently-connected device is an operable device, then the determination of the step S496 becomes affirmative “YES,” and the third status check routine proceeds to a step S497.

The step S497 is implemented to enter data into the availability table 52, which indicates that the third interface has been provided to the PC 1, and an operable device has been connected with the third interface. For example, as illustrated in FIG. 5, the availability table 52 is updated to reflect the content that the parallel interface 36 is present, and a device has been connected with the parallel interface 36.

Then, one cycle of execution of the third status check routine is terminated, and subsequently, the install program proceeds to the step S150 illustrated in FIG. 2.

As will be evident from the above explanation, in the present embodiment, upon execution by the PC 1, of the step S160 of the install program illustrated in FIG. 2, the interface selection screen is displayed in a display manner variable depending on the presence/absence of each of the plurality of interfaces different in kind. Through the interface selection screen, the user is guided to correctly specify a particular interface.

Describing more specifically, upon implementation of the step S160 illustrated in FIG. 2, the interface selection screen is displayed on the display unit 18 with the plurality of radio buttons corresponding to the plurality of interfaces, respectively, in a displayed manner that one of the radio buttons is initially displayed in a picked state (on-state). The one radio button corresponds to a connection type which conforms with the presence/absence of each interface and the status of connection with devices. The presence/absence and the status are verified as a result of implementation of the steps S120-140.

On the interface selection screen displayed in the above displayed manner, the content is visually presented to the user that a device driver corresponding to an interface conforming with the verified connection type is to be installed in the PC 1.

Therefore, in the present embodiment, it is more likely that such a device driver will be installed by and in the PC 1 that allows an appropriate operation of a particular device by the PC 1, even though the user performs an action via the input unit 16 indicating verification of the content of the interface selection screen without any previous re-selection of a picked (on-state) radio button.

Therefore, even if the user without an adequate knowledge about the connection type performs an action indicating the above verification without any previous re-selection of a picked (on-state) radio button, it is less likely that such a device driver will be installed by and in the PC 1 that fails to allow an appropriate operation of a particular device by the PC 1.

Thus, the present embodiment allows the interface selection screen to be displayed, in view of the kind of an interface actually provided to the PC 1, in a manner variable depending on the presence/absence of an interface and the status of connection with a device. Therefore, the present embodiment allows the user to correctly specify a particular interface, with the aid of the interface selection screen. As a result, the present embodiment prevents the situation where installation is not correctly completed from being encountered.

In addition, in the present embodiment, upon execution of the step S150 illustrated in FIG. 2 by the PC 1, a device driver to be installed is determined by referring to not only the content of the verification (the content of the availability table 52) obtained by the execution of the steps S120-140, but also the priority pre-established between the plurality of interfaces different in kind.

Therefore, in the present embodiment, the step S150 illustrated in FIG. 2 is implemented even in the case where a mere consideration of the content of the availability table 52 would lead to a determination that more than one device driver is to be installed, and as a result, these device drivers are narrowed down into a single device driver according to the priority between a plurality of interfaces.

As described above, each time that the install program illustrated in FIG. 2 is executed by the PC 1, the step S110 is implemented to determine whether or not the current execution of the install program is for the first-time installation of a device driver. If the current execution is not for the first-time installation, then the step S200 is implemented to select one of a plurality of interfaces which is identified by the aforementioned driver information, and then to determine that a device driver corresponding to the selected interface is to be installed in the PC 1.

The driver information that is referred to for determining a device driver to be installed is information that was stored in the registry 50 at previous installation of a device driver, and that can identify one of a plurality of interfaces that corresponds to the previously-installed device driver.

Therefore, once the step S160 is implemented after the step S200 is implemented, the interface selection screen is displayed on the display unit 18 in a manner that there is initially displayed in a picked state (on-state), one of the plurality of radio buttons which corresponds to a connection type provided by an interface corresponding to the previously-installed device driver.

There arises a need to re-install a device driver identical in kind to a previously-installed one, when a device driver is needed to be updated, when the same device driver is needed to be re-installed because the previous device driver was damaged, or the like. In these cases, it is adequate to update only a device driver, and it is not needed to modify, in addition to the device driver, an interface connecting the PC 1 with the device.

In this regard, in the present embodiment, as described above, there is initially displayed in a picked state (on-state) on the interface selection screen, one of the plurality of radio buttons which corresponds to a connection type identical to a previous one, thereby allowing the user to specify a particular interface through the interface selection screen. Therefore, the present embodiment is more advantageous in preventing the user from unnecessarily modifying the kind of an interface.

As will be readily understood from the above, in the present embodiment, the PC 1 constitutes an example of the “apparatus for processing information” set forth in the above mode (1), the steps S120, 130, and 140 each constitute an example of the “determining step” set forth in the same mode, the steps S150, 160, and 200 together constitute an example of the “presenting step” set forth in the same mode, and the step S170 constitutes an example of the “installing step” set forth in the same mode.

Further, in the present embodiment, the steps S150 and 200 each constitute an example of the “defining step” set forth in the above mode (5), and the step S160 constitutes an example of the “step of presenting to the user” set forth in the same mode.

Still further, in the present embodiment, the step S180 constitutes an example of the “storing step” set forth in the above mode (9), and the hard disc 14 constitutes an example of the “storage” set forth in the same mode.

Still further, in the present embodiment, the steps S310 and 320 illustrated in FIG. 7 together constitute an example of the “determining step” set forth in the above mode (1), with respect to the first interface, the steps S410 and 420 illustrated in FIG. 8 together constitute an example of the “determining step” set forth in the above mode (1), with respect to the second interface, and the steps S490 and 491 illustrated in FIG. 9 together constitute an example of the “determining step” set forth in the above mode (1), with respect to the third interface.

Additionally, in the present embodiment, the PC 1 constitutes an example of the “apparatus for processing information” set forth in the above mode (15).

Still additionally, in the present embodiment, a portion of the controller 12 which is assigned to implement the steps S120-140 constitutes an example of the “determining section” set forth in the above mode (15), a portion of the controller 12 which is assigned to implement the step S160 constitutes an example of the “connection selection section” set forth in the same mode, and a portion of the controller 12 which is assigned to implement the step S170 constitutes an example of the “installation section” set forth in the same mode.

Further, in the present embodiment, the input unit 16 constitutes an example of the “input unit” set forth in the above mode (16), the display unit 18 constitutes an example of the “display unit” set forth in the same mode, a portion of the controller 12 which is assigned to implement the step S160 constitutes an example of the “displaying division” set forth in the same mode, and a portion of the controller 12 which is assigned to implement the steps S150 and 200 constitutes an example of the “identifying division” set forth in the same mode.

Yet further, in the present embodiment, a portion of the controller 12 which is assigned to implement the steps S310, 320, 410, 420, 490, and 491 constitutes an example of the “determining division” set forth in the above mode (17), and a portion of the controller 12 which is assigned to implement step S160 constitutes an example of the “presenting division” set forth in the same mode.

Still further, in the present embodiment, a portion of the controller 12 which is assigned to implement the steps S310, 320, 410, 420, 490, and 491 constitutes an example of the “first division” set forth in the above mode (18), a portion of the controller 12 which is assigned to implement steps S340, 350, 370, 440, 450, 470, 493, 494, and 496 constitutes an example of the “second division” set forth in the same mode, and a portion of the controller 12 which is assigned to implement the steps S150, 160, and 200 constitutes an example of the “presenting division” set forth in the same mode.

Additionally, in the present embodiment, a portion of the controller 12 which is assigned to implement the steps S150 and 200 constitutes an example of the “defining section” set forth in the above mode (19), and a portion of the controller 12 which is assigned to implement the step S160 constitutes an example of the “presenting division” set forth in the same mode.

Yet additionally, in the present embodiment, a portion of the controller 12 which is assigned to implement the step S150 constitutes an example of the “defining division” set forth in the above mode (20).

Next, there will be described a PC 1 constructed according to a second embodiment.

The present embodiment is common in hardware construction to the first embodiment, and is common also in software construction thereto, except only a portion of an install program. In view of this, the install program in the present embodiment will be described in greater detail, with the common elements of the present embodiment to the first embodiment being referred to by the identical reference numerals or names, without a redundant explanation of these common elements.

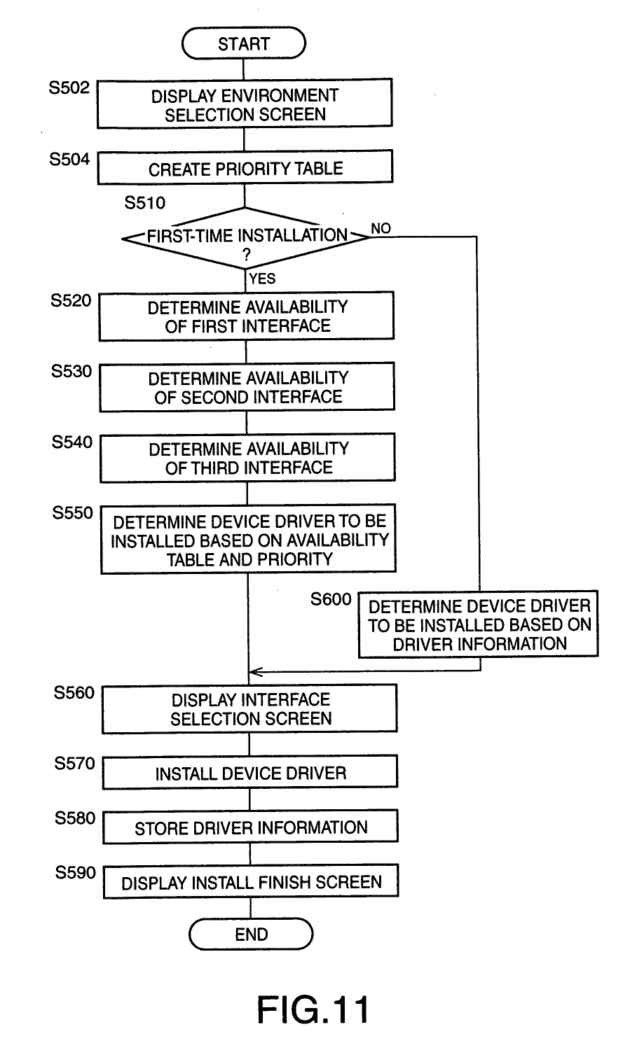

FIG. 11 schematically illustrates in flow chart the install program executed in the PC 1 constructed according to the present embodiment. The install program, because of its minor difference from that of FIG. 2, will be described with respect to only the minor difference.

The install program illustrated in FIG. 11 is initiated with a step S502 to cause the display unit 18 to display an environment selection screen for allowing the user to specify a particular operating environment in which the PC 1 operates.

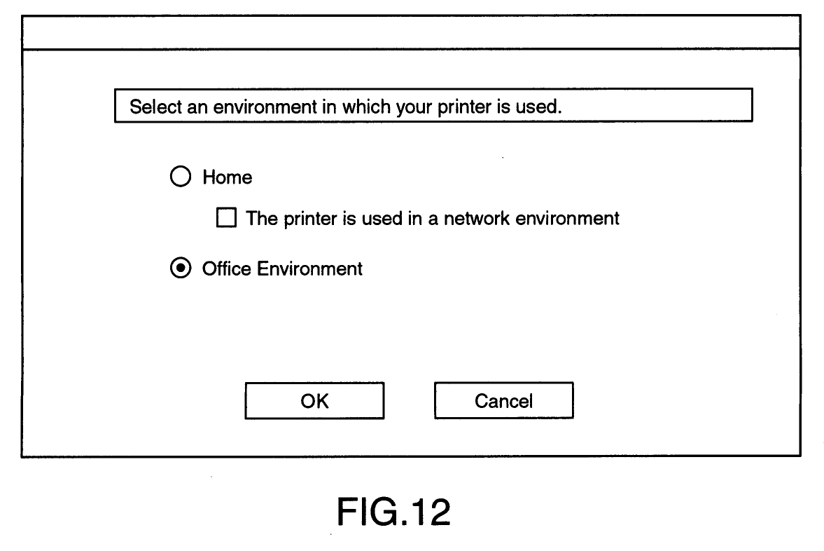

FIG. 12 illustrates an example of the environment selection screen. The example is displayed on the display unit 18 for allowing the user to select one of a plurality of radio buttons, for thereby allowing the user to specify an environment in which the PC 1 operates.

In the example illustrated in FIG. 12, there are displayed on the environment selection screen, two radio buttons corresponding to a “home” and an “office environment,” respectively. There is additionally displayed on the environment selection screen, a check box which becomes active upon selection of the radio button corresponding to the “home.” The check box is used so as to be tuned on by the user who uses the PC 1 at home in a network environment (in which the PC 1 is connected with a LAN).

Upon display of the environment selection screen on the display unit 18, the user performs an action via the input unit 16 for selecting one of the radio buttons (additionally turning on the check box, if necessary). Thereafter, the user performs an action via the input unit 16 for specifying the operating environment corresponding to the selected radio button, as the operating environment in which the PC 1 operates (for example, the user selects an “OK” button, in the example illustrated in FIG. 12).

Once the user performs an action for specifying a particular operating environment through the environment selection screen, a step S504 is implemented to create the priority table 70 defining priority between a plurality of interfaces, depending on the operating environment specified by the user. The created priority table 70 is stored in the RAM 12b.

The priority between a plurality of interfaces, although is fixedly determined in the first embodiment, is flexibly determined depending on variations in the kind of the operating environment specified by the implementation of the step S502 in the present embodiment.

More specifically, if the “office environment” is specified as the operating environment by the implementation of the step S502, or if the “home” is specified as the operating environment and the check box is turned on, then it is estimated that the connection between the PC 1 and a particular device is achieved via the network interface 32.

In this case, the priority table 70 is created to indicate that the network interface 32 is first in order, the USB interface 34 is second in order, and the parallel interface 36 is third in order. FIG. 10 illustrates the content of the thus-created priority table 70.

On the other hand, if the “home” is specified as the operating environment by the implementation of the step S502, and if the check box is not tuned on, then it is estimated that the connection between the PC 1 and a particular device is achieved via the USB interface 34 which has been widely popularized.

In this case, the priority table 70 is created to indicate that the USB interface 34 is first in order, the network interface 32 is second in order, and the parallel interface 36 is third in order.

Upon implementation of the step S504 illustrated in FIG. 11, steps S510-600 are implemented similarly to the steps S110-200 illustrated in FIG. 2. In particular, the step S550 (corresponding to the step S150, in FIG. 2) is implemented to determine a device driver to be installed, based on the availability table 52 and the priority table 70 created in the step S502.

As will be readily understood from the above explanation, the present embodiment provides the same functions and effects, owing to the same construction, as those of the first embodiment, further provides the following functions and effects, owing to its unique construction.

In the present embodiment, the priority between a plurality of interfaces is so flexibly determined that the priority level of one of the interfaces that corresponds to the actual operating environment of the PC 1 is higher than those of the remaining interfaces. The interface selection screen is displayed so as to reflect the thus-determined priority, thereby guiding the user to correctly specify a particular interface through the interface selection screen.

Operating environments of the PC 1 in which a device driver is to be installed includes an environment in which the PC is stand-alone in use, such as where the PC 1 is used by an individual user at home, and an environment in which the PC 1 is used through a network, such as where the PC 1 is used in a business environment (office environment). An interface with which a particular device is connected may be varied in kind by the kind of the actual operating environment of the PC 1.

For example, for the operating environment in which the PC 1 is stand-alone in use, a typically-used interface is one for directly connecting the PC 1 with a particular device (the USB interface 34, and the parallel interface 36, in the present embodiment). In contrast, for the operating environment in which the PC 1 is used through the network 100, a typically-used interface is one for indirectly connecting the PC 1 with a particular device via the network 100 (the network interface 32, in the present embodiment).

That is to say, variations in the kind of the operating environment of the PC 1 invite variations in the kind of an interface connected to a particular device operated under a device driver. Therefore, the present embodiment allows the priority between a plurality of interfaces to be determined depending on the kind of the actual operating environment of the PC 1, thereby guiding the user to correctly specify a particular interface.

As will be evident from the above explanation, in the present embodiment, the step S550 illustrated in FIG. 11 constitutes an example of the “defining step” set forth in the above mode (5), and the step S560 constitutes an example of the “presenting step” set forth in the same mode.

Further, in the present embodiment, the step S502 illustrated in FIG. 11 constitutes an example of the “allowing step” set forth in the above mode (8).

Additionally, in the present embodiment, a portion of the controller 12 which is assigned to implement the step S502 constitutes an example of the “environment selection section” set forth in the above mode (22).

Still additionally, in the present embodiment, the hard disc 14 constitutes an example of the “storage” set forth in the above mode (24), a portion of the controller 12 which is assigned to implement the step S580 constitutes an example of the “storing section” set forth in the same mode, and a portion of the controller 12 which is assigned to implement the steps S560 and 600 constitutes an example of the “presenting division” set forth in the same mode.

The present invention, although has been described above with respect to these embodiments, is not limited thereto, and may be embodied in alternative various modes, without departing from the gist of the present invention, not to mention.

For example, in the above embodiments, the plurality of interfaces different in kind, the availability of which is determined by the implementation of the steps S120-140 are comprised of three different interfaces, namely, the network interface 32, the USB interface 34, and the parallel interface 36.

In practicing the present invention, other different interface may be employed alternatively or additionally, and the number of such interfaces may be increased or decreased.

In the above embodiments, the interface selection screen displayed on the display unit 18 by the implementation of the step S160 illustrated in FIG. 2 is varied in the displayed manner (for example, which one of a plurality of options is initially displayed in an on-state (a selected state), these options being to be selected by the user), depending on changes in the results of the implementation of the step S150, resulting in changes in the content of the selection support information presented to the user for allowing or supporting the user to specify a particular interface.

In practicing the present invention, the content of the selection support information presented to the user may be varied depending on the result of the implementation of the step S150 in an alternative approach.

For example, for achieving the same goal, the present invention may be practiced such that the screen image as such is varied depending on the result of the implementation of the step S150.

Also, the present invention may be practiced such that the sequence in which successive steps including the step S160 and its following steps of the install program are respectively implemented is varied depending on the result of the implementation of the step S150, whereby the content of the selection support information presented to the user is varied depending on the result of the implementation of the step S150.

Still also, in the above embodiments, the implementation of the step S160 illustrated in FIG. 2 allows the display unit 18 to display the interface selection screen, in a manner that one of the plurality of radio buttons which corresponds to a connection type provided under the interface determined by the implementation of the step S150. As a result, there is presented to the user the selection support information indicating that a device driver corresponding to the interface of the above connection type is to be installed in the PC 1.

In practicing the present invention, an alternative arrangement may be employed for indicating visually to the user that a device driver corresponding to an interface of a particular connection type is to be installed in the PC 1.

For example, such an arrangement may be employed that the interface selection screen is displayed in a manner that only one(s) of all the radio buttons which correspond(s) to a connection type of an interface determined by the implementation of the step S150 are selectable, and the remaining radio button(s) is not selectable. In this arrangement, these radio buttons may be replaced with a plurality of check boxes.

Also, such an arrangement may be employed that the interface selection screen is displayed with a message (e.g., in text) indicating that a device driver corresponding to an interface determined by the implementation of the step S150 to be installed in the PC 1.

In any arrangement, there is indicated to the user that an interface which has been provided to the PC 1, and which has been connected to a particular device is to be specified by the user, in a clearly understandable fashion.

Therefore, if the user specifies a particular interface through the thus-displayed interface selection screen, then the user is avoided from incorrectly specifying an interface which has not been provided to the PC 1, or an interface which has not connected to a particular device.

As a result, incorrect installation to the PC 1 is avoided, of a device driver corresponding to an interface which has not been provided to the PC 1, or of a device driver corresponding to an interface which has not connected to a particular device.

In the above embodiments, the step S150 illustrated in FIG. 2 is implemented to determine any one of device drivers to be installed, and the step S160 is implemented to display the interface selection screen in a manner that there is initially displayed in an on-state (or a selected state), one of the radio buttons which corresponds to a connection type under an interface corresponding to the determined device driver. That is to say, it is indicated to the user that any one of the device drivers is to be installed.

Alternatively, the present invention may be practiced, for example, in an arrangement allowing the step S160 illustrated in FIG. 2 to be implemented based on the content of data stored in the availability table 52 by the implementation of the steps S120-140, such that it is indicated to the user that more than one device driver is each installable to the PC 1.

More specifically, in the above arrangement, if it is determined based on the content of the availability table 52, that more than one interface has been provided to the PC 1 (in FIG. 5, the column of “presence/absence” is assigned “presence,” with respect to each of more than one interfaces), or that a particular device has been connected respectively to more than one interface (in FIG. 5, the column of “status of connection” is assigned “device connected,” with respect to each of more than one interface), then the step S160 is implemented to display the interface selection screen in a manner that it is indicated to the user that all the device drivers corresponding to the above interfaces are each installable to PC 1, or that the above interfaces are each selectable.

In a mode for practicing the above arrangement, the step S150 illustrated in FIG. 2 may be implemented, for example, to determine that device drivers corresponding to the following interfaces, respectively, each are to be installed or each are installable. For the above interfaces, the availability table 52 has stored therein information indicating that these interfaces each have been provided to the PC 1, or that these interfaces each have been connected to a particular device.

In an alternative mode for practicing the above arrangement, the step S160 illustrated in FIG. 2 may be implemented, for example, to display the interface selection screen in a displayed manner that all the ones of a plurality of check boxes which correspond to connection types of all the interfaces determined by the implementation of the step S150 are each displayed in a turned-on state.

The step S160 is further implemented to display the interface selection screen with a message indicating that each device driver corresponding to each of the interfaces determined by the implementation of the step S150 is to be installed or installable in the PC 1.

Upon practice of the above arrangement in any mode, it is indicated visually to the user that one or more of all the interfaces which each have been provided to the PC 1, or which each have been connected to a particular device are to be specified by the user, allowing the user to specify one or more particular interfaces according to the visual indication to the user.

Therefore, in the above arrangement, the user selection of an interface(s) through the interface selection screen prevents the user from incorrectly selecting an interface which has not provided to the PC 1, or an interface which has not connected to a particular device. As a result, incorrect installation to the PC 1 is avoided, of a device driver corresponding to an interface which has not been provided to the PC 1, or of a device driver corresponding to an interface which has not connected to a particular device.

In the above embodiments, in order for a device driver to be installed for being determined in the step S150 illustrated in FIG. 2, not only the availability table 52 but also the priority level of each interface are referred to.

Alternatively, the step S150 may be implemented such that, for determining a device driver to be installed, at least one parameter other than the priority level is referred to, thereby narrowing down device driver options into a particular device driver to be installed.

In the above embodiments, the priority that is referred to in the step S150 illustrated in FIG. 2 is pre-established as a fixed priority. The priority may be established according to a rule, for example, stating that a commonly popularized interface or an interface with which a particular device is suitably connected is higher in priority order than others.

The possibility can arise that a device driver is varied in kind with changes in the kind of a device operable under the device driver, and that changes in the kind of a device operable under a device driver invite changes in the kind of an interface of the PC 1 with which the device is to be connected. That is to say, changes in the kind of a device driver invite changes in the kind of an interface of the PC 1 with which a device operable under the device driver is to be connected.

In view of the above findings, the aforementioned priority may be determined in a determination manner such that the priority is varied in level with changes in the kind of a device driver to be installed.

Once the determination manner is implemented, the priority between a plurality of interfaces are determined such that the priority level of one of the plurality of interfaces which conforms with a device driver to be installed is higher than those of the remaining interface(s). This allows the user to specify a particular interface, using the interface selection screen displayed so as to reflect the thus-determined priority.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A computer-readable program product for causing a computer of an apparatus for processing information in an environment in which the apparatus is connected with a device via a selected one of a plurality of interfaces different in kind, to implement a process for installing to the apparatus a device driver in conformity with the connected device, the process comprising the steps of:
determining whether or not each of the plurality of interfaces is available to the apparatus, thereby recognizing interface availability;
prior to an event of a user to specify one of the plurality of interfaces, presenting to the user, selection support information supporting the user in specifying one of the plurality of interfaces, depending upon the recognized interface availability, thereby allowing the user to specify one of the plurality of interfaces in conformity with the recognized interface availability; and
selecting one of a plurality of device drivers different in kind which are all available to the device, in conformity with the specified interface, thereby installing the selected device driver to the apparatus.

2. The computer-readable program product according to claim 1, wherein the apparatus comprises:
an input unit for allowing the user to enter a user indication into the apparatus, depending on a user action; and
a display unit for displaying information to the user, and wherein the presenting step comprises the steps of:
causing the display unit to display an interface selection screen which is configured for prompting the user to specify one of the plurality of interfaces and for displaying the selection support information; and
in response to the input unit recognizing the user action for specifying one of the plurality of interfaces during display of the interface selection screen, identifying the specified interface based on a content of the user action.

3. The computer-readable program product according to claim 1, wherein the determining step comprises the step of determining whether or not each of the plurality of interfaces has been provided to the apparatus, and
wherein the presenting step comprises the step of presenting to the user the selection support information to inform the user that the user can specify any one of at least one of the plurality of interfaces which is determined to have been provided to the apparatus.

4. The computer-readable program product according to claim 1, wherein the determining step comprises the steps of:
determining whether or not each of the plurality of interfaces has been provided to the apparatus; and
determining whether or not the device has been connected with each of at least one of the plurality of interfaces which is determined to have been provided to the apparatus, and
wherein the presenting step comprises the step of presenting to the user the selection support information to inform the user that it is recommended that the user specify at least one of the plurality of interfaces which is determined to have been provided to the device.

5. The computer-readable program product according to claim 1, further comprising the step of defining the selection support information based on the recognized interface availability, and
wherein the presenting step comprises the step of presenting to the user the defined selection support information, thereby allowing the user to specify one of the plurality of interfaces in conformity with the recognized interface availability.

6. The computer-readable program product according to claim 5, wherein the defining step comprises the step of defining the selection support information in conformity with the recognized interface availability, and in conformity with pre-established priority for operation between the plurality of interfaces.

7. The computer-readable program product according to claim 6, wherein the priority is pre-established to be varied depending on a kind of one of the plurality of device drivers which is to be installed.

8. The computer-readable program product according to claim 6, further comprising the step of allowing the user to specify an operating environment in which the apparatus operates, and
wherein the priority is pre-established to be varied depending on a kind of the specified operating environment.

9. The computer-readable program product according to claim 8, wherein the operating environment is selected from a stand-alone environment in which the apparatus is communicated with the device without intervention of any network, and a network environment in which the apparatus is communicated with the device via a network.

10. The computer-readable program product according to claim 1, wherein the apparatus comprises a storage for storing information,
wherein the process further comprises the step of storing in the storage, information for identifying one of the plurality of interfaces which corresponds to one of the plurality of device drivers which has been installed within the apparatus, and
wherein the presenting step comprises the step of, after the one device driver has been installed within the apparatus, prior to another event of installation, presenting to the user the selection support information to inform the user that it is recommended that the user specify the interface identified by the information stored in the storage.

11. In a computer of an apparatus for processing information in an environment in which the apparatus is connected with a device via a selected one of a plurality of interfaces different in kind, a process for installing to the apparatus a device driver in conformity with the connected device, the process comprising the steps of:
determining whether or not each of the plurality of interfaces is available to the apparatus, thereby recognizing interface availability;
prior to an event of a user to specify one of the plurality of interfaces, presenting to the user, selection support information supporting the user in specifying one of the plurality of interfaces, depending upon the recognized interface availability, thereby allowing the user to specify one of the plurality of interfaces in conformity with the recognized interface availability; and
selecting one of a plurality of device drivers different in kind which are all available to the device, in conformity with the specified interface, thereby installing the selected device driver to the apparatus.

12. An install program to be executed in an apparatus for processing information using a computer, the install program being executed by the computer for implementing the process according to claim 11.

13. An apparatus for processing information using a computer, the apparatus having installed therein the install program according to claim 12.

14. An apparatus for processing information using a computer, the apparatus having installed therein a device driver as a result of execution of the install program according to claim 12.

15. An apparatus for processing information using a computer in an environment in which the apparatus is connected with a device via a selected one of a plurality of interfaces different in kind, the apparatus comprising:
a determining section determining whether or not each of the plurality of interfaces is available to the apparatus, thereby recognizing interface availability;
a connection selection section, prior to an event of a user to specify one of the plurality of interfaces, presenting to the user, selection support information supporting the user in specifying one of the plurality of interfaces, depending upon the recognized interface availability, thereby allowing the user to specify one of the plurality of interfaces in conformity with the recognized interface availability; and
an installation section selecting one of a plurality of device drivers different in kind which are all available to the device, in conformity with the specified interface, thereby installing the selected device driver to the apparatus.

16. The apparatus according to claim 15, further comprising:
an input unit for allowing the user to enter a user indication into the apparatus, depending on a user action; and
a display unit for displaying information to the user, and wherein the connection selection section comprises:
a displaying division causing the display unit to display an interface selection screen which is configured for prompting the user to specify one of the plurality of interfaces and for displaying the selection support information; and
an identifying division, in response to the input unit recognizing the user action for specifying one of the plurality of interfaces during display of the interface selection screen, identifying the specified interface based on a content of the user action.

17. The apparatus according to claim 15, wherein the determining section comprises a determining division determining whether or not each of the plurality of interfaces has been provided to the apparatus, and
wherein the connection selection section comprises a presenting division presenting to the user the selection support information to inform the user that the user can specify any one of at least one of the plurality of interfaces which is determined to have been provided to the apparatus.

18. The apparatus according to claim 15, wherein the determining section comprises:
a first division determining whether or not each of the plurality of interfaces has been provided to the apparatus; and
a second division determining whether or not the device has been connected with each of at least one of the plurality of interfaces which is determined to have been provided to the apparatus, and
wherein the connection selection section comprises a presenting division presenting to the user the selection support information to inform the user that it is recommended that the user specify at least one of the plurality of interfaces which is determined to have been provided to the device.

19. The apparatus according to claim 15, further comprising a defining section defining the selection support information based on the recognized interface availability, and
wherein the connection selection section comprises a presenting division presenting to the user the defined selection support information, thereby allowing the user to specify one of the plurality of interfaces in conformity with the recognized interface availability.

20. The apparatus according to claim 19, wherein the defining section comprises a defining division defining the selection support information in conformity with the recognized interface availability, and in conformity with pre-established priority for operation between the plurality of interfaces.

21. The apparatus according to claim 20, wherein the priority is pre-established to be varied depending on a kind of one of the plurality of device drivers which is to be installed.

22. The apparatus according to claim 20, further comprising an environment selection section allowing the user to specify an operating environment in which the apparatus operates, and
wherein the priority is pre-established to be varied depending on a kind of the specified operating environment.

23. The apparatus according to claim 22, wherein the operating environment is selected from a stand-alone environment in which the apparatus is communicated with the device without intervention of any network, and a network environment in which the apparatus is communicated with the device via a network.

24. The apparatus according to claim 15, further comprising:
a storage for storing information; and
a storing section storing in the storage, information for identifying one of the plurality of interfaces which corresponds to one of the plurality of device drivers which has been installed within the apparatus, and
wherein the connection selection section comprises a presenting division, after the one device driver has been installed within the apparatus, prior to another event of installation, presenting to the user the selection support information to inform the user that it is recommended that the user specify the interface identified by the information stored in the storage.
